(19) United States
(12) Patent Application Publication
(10) Pub. No.: US 2004/0119010 A1
(43) Pub. Date: Jun. 24, 2004

(54) Quantitative analysis of protein isoforms using matrix-assisted laser desorption/ionization time of flight mass spectrometry

(75) Inventors: M. Benjamin Perryman, Garretson, SD (US); Steve M. Helmke, Denver, CO (US); Mark W. Duncan, Denver, CO (US)

Correspondence Address: FULBRIGHT & JAWORSKI L.L.P., SUITE 2400, 600 CONGRESS AVENUE, AUSTIN, TX, 78701-3271, US

(73) Assignee: The Regents of the University of Colorado

(21) Appl. No.: 10/697,991

(22) Filed: Oct. 30, 2003

Related U.S. Application Data
(60) Provisional application No. 60/423,019, filed on Nov. 1, 2002.
(60) Provisional application No. 60/423,142, filed on Nov. 2, 2002.

(51) Int. Cl. H01J 49/00

(52) U.S. Cl. 250/281

(57) ABSTRACT

The present invention provides for methods of quantitating the amounts of proteins or peptides, including those that are closely related isoforms, using matrix-assisted laser desorption/ionization time of flight mass spectrometry (MALDI-TOF-MS). Measurement of protein concentrations in vivo has been extremely difficult and problematic, and protein concentrations have not been shown to correlate well with mRNA levels, the standard used in the past. The present invention overcomes the deficiencies of prior methodologies by taking advantage of MALDI-TOF-MS technology and applying it to proteins and peptides in a way that allows for accurate, quantitative measurement in vivo of protein or peptide concentrations.

### BACKGROUND OF THE INVENTION

The present invention claims benefit of priority to U.S. Provisional Serial No. 60/423,019, filed Nov. 1, 2002, and No. 60/423,142, filed Nov. 2, 2002, the entire contents of which are hereby incorporated by reference without reservation.

1. Field of the Invention

The present invention relates generally to the fields of proteomics. More particularly, it concerns measurement of protein concentrations in a synthetic or biological sample. Specifically, the invention relates to the use of matrix-assisted laser desorption/ionization time of flight mass spectrometry (MALDI-TOF-MS) to quantitatively measure the concentration of proteins in a synthetic or biological sample. More specifically, the invention relates to the use of MALDI-TOF-MS to measure the relative and quantitative amounts of closely related protein isoforms or phosphoisoforms from a synthetic or biological sample.

2. Description of Related Art

With the completion of the Human Genome Project, the emphasis is shifting to examining the protein complement of the human organism. This has given rise to the science of proteomics, the study of all the proteins produced by cell type and organism. At the same time, there has been a revival of interest in proteomics in many prokaryotes and lower eukaryotes as well.

The term proteome refers to all the proteins expressed by a genome, and thus proteomics involves the identification of proteins in the body and the determination of their role in physiological and pathophysiological functions. The ˜30,000 genes defined by the Human Genome Project translate into 300,000 to 1 million proteins when alternate splicing and post-translational modifications are considered. While a genome remains unchanged to a large extent, the proteins in any particular cell change dramatically as genes are turned on and off in response to their environment.

As a reflection of the dynamic nature of the proteome, some researchers prefer to use the term “functional proteome” to describe all the proteins produced by a specific cell in a single time frame. Ultimately, it is believed that through proteomics, new disease markers and drug targets can be identified that will help design products to prevent, diagnose and treat disease.

Proteomics has much promise in novel drug discovery via the analysis of clinically relevant molecular events. The future of biotechnology and medicine will be impacted greatly by proteomics, but there is much to do in order to realize the potential benefits.

With the availability of DNA microarray analysis, permitting the expression of thousands of genes to be monitored simultaneously, the importance of the proteome cannot be overstated as it is the proteins within the cell that provide structure, produce energy, and allow communication, movement and reproduction. Basically, proteins provide the structural and functional framework for cellular life.

However, there are several impediments in the study of proteins that are not inherent in the study of nucleic acids. Proteins are more difficult to work with than DNA and RNA. Proteins cannot be amplified like DNA, and are therefore less abundant sequences are more difficult to detect. Proteins have secondary and tertiary structure that must often be maintained during their analysis. Proteins can be denatured by the action of enzymes, heat, light or by aggressive mixing as in beating egg whites. Some proteins are difficult to analyze due to their poor solubility.

Although nucleic acids are easier to work with, there also are limitations to the information that can be derived from DNA/RNA analysis. DNA sequence analysis does not predict if a protein is in an active form. Similarly, RNA quantitation does not always reflect corresponding protein levels. Multiple proteins can be obtained from each gene when post-translational modification and mRNA splicing are taken into account. Thus, DNA/RNA analysis cannot predict the amount of a gene product that is made, if and when a gene will be translated, the type and amount of post-translational modifications, or events involving multiple genes such as aging, stress responses, drug responses and pathological transformations. Clearly, genomics and proteomics are complementary fields, with proteomics extending functional analysis. This once again highlights the important nature of proteomic information.

### SUMMARY OF THE INVENTION

Thus, in accordance with the present invention, there is provided a method to quantitate the amount of protein or peptide that is contained in a selected sample comprising (a) obtaining a sample of the protein or peptide of interest, (b) providing a standard protein or peptide that is derived from the protein or peptide of interest and is in a known or measurable quantity for comparison to the protein or peptide of interest, (c) co-crystallizing the target protein or peptide and standard with a matrix, (d) analyzing the crystallized protein or peptide and standard using MALDI-TOF-MS; and (e) determining the amount of the protein or peptide present in the sample based on the analysis in (d) and comparison to the standard.

In another embodiment of the invention, there is provided a method to comparatively analyze and quantitate the amount of a plurality of structurally distinct proteins or peptides in a sample comprising (a) obtaining one or more samples containing multiple distinct target proteins or peptides, (b) providing a standard protein or peptide corresponding to each target protein wherein each standard is a derivative of each target protein or peptide of interest at a known or measurable quantity, (c) co-crystallizing the target proteins or peptides and standards with a matrix, (d) analyzing the crystallized target proteins or peptides and standards with MALDI-TOF-MS; and (e) determining the amounts of each target protein or peptide analyzed that is present in the sample.

In one embodiment of the invention, the proteins are isoforms of the same protein, and in another embodiment these isoforms are phosphoisoforms of the same protein.

In a particular embodiment of the invention, the sample may be derived from a cell, a prokaryotic cell, a eukaryotic cell, a mammalian cell, a human cell, or a human cardiomyocyte. The sample may also be derived from an organ, a human organ, or the human heart. The sample may further be derived from plasma or from serum.

In yet another particular embodiment, the protein of interest may be α myosin heavy chain, β myosin heavy chain, skeletal actin, or cardiac actin.

In a particular embodiment of the invention, the peptides may be produced by proteolytic cleavage. They may also be produced by chemical cleavage or enzymatic digestion. In yet a further embodiment, this enzymatic cleavage can be performed by an endopeptidase, a protease, or any proteolytic digestive enzyme.

In another embodiment of the invention, the standards used to quantitate the concentrations of protein can be produced synthetically. They can further be derived by modifying a single amino acid from the target protein or peptide.

In a variation on the invention, the method may not utilize standards but, rather, may involve determining relative quantities of two proteins by comparing unique aspects of the individual MALDI-TOF profiles, as compared to standard profiles. These proteins may be isoforms of each other.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1—Peptides of myosin heavy chain from atrial tissues. Total protein was extracted from samples of human heart atria and resolved by SDS gel electrophoresis. The MyHC protein band was excised and in-gel digested with sequencing grade trypsin. The tryptic peptides were extracted, mixed with matrix, and subjected to MALDI-TOF MS. The peptide masses were used to search the SwissProt database with the MSFit program. The top panel was matched to α-MyHC while the bottom panel was matched to β-MyHC. The spectra were analyzed in detail to find peptides that discriminated between α-MyHC and β-MyHC, that had identical trypsin cleavage sites, and that differed by a single conservative amino acid substitution. The peptides that fit these criteria and had the strongest ion currents were at m/z 1768.96 and 1740.93 respectively and were chosen as the quantification peptides.

FIG. 2—Myosin heavy chain quantification peptides. The sequences of the quantification peptides and their surrounding tryptic cleavage sites are shown above. A third peptide was designed to be highly homologous to these but have a unique mass not found in either MyHC spectra. This peptide was used as an internal standard and its sequence is also shown above. Amino acid residues that differ among the quantification and internal standard peptides are underlined.

FIGS. 3A & 3B—MALDI-TOF mass spectra of quantification peptides. FIG. 3A. The quantification peptides are shown in a narrow window of the MALDI-TOF mass spectrum of a sample of atrial MyHC (patient 1). The ratio of the ion current of the α-MyHC peptide to the β-MyHC peptide was converted to the peptide ratio by the standard curve of FIG. 4 and was consistent with the α-MyHC/β-MyHC protein ratio determined by silver stained gel. These results indicated the feasibility of measuring isoform ratios by MALDI-TOF-MS. FIG. 3B. A 2 pmol aliquot of the IS peptide was added to a replica sample of atrial MyHC. The same narrow window of the MALDI-TOF mass spectrum is shown. The pmol values of α-MyHC peptide and β-MyHC peptide determined from this spectrum using the standard curves of FIG. 6 are indicated.

FIG. 4—α-MyHC peptide/β-MyHC peptide ratio standard curve. The MyHC quantification peptides shown in FIG. 2 were synthesized and purified by HPLC to use as standards. These peptides were mixed in various proportions expressed in terms of the % α-MyHC peptide. These peptide mixtures were mixed with matrix and subjected to MALDI-TOF MS. The ion currents of the α-MyHC peptide and the β-MyHC peptide were measured and expressed as the % a ion current. Each point represents the average of ten measurements and error bars represent standard deviations (less than 1.2%). Regression analysis indicated a linear relationship between ion current ratio and peptide ratio (slope of 0.99 and r2=0.998).

FIG. 5—Comparison of the silver stained gel method and the MALDI-TOF MS method. Regression analysis was performed on a comparison of the % α-MyHC values determined by silver stained gels and by the new MALDI-TOF MS method. There was good agreement between the methods over a range of ratios as demonstrated by a linear relationship with a slope of 1.01 (r2=0.979).

FIGS. 6A & 6B—FIG. 6A. α-MyHC peptide standard curve. The internal standard peptide shown in FIG. 2 was prepared synthetically and purified by HPLC. The internal standard peptide was mixed with the α-MyHC peptide and subjected to MALDI-TOF MS. The samples spotted onto the MALDI plate contained 2 pmol of the internal standard peptide and 0-6 pmol of the α-MyHC peptide. The ion current ratio (α/IS) was measured and plotted against the amount of α-MyHC peptide. Each point represents the average of ten measurements and error bars represent standard deviations. Regression analysis indicated a linear relationship between ion current ratio (α/IS) and the amount of α-MyHC peptide (slope of 0.42 and r2=0.994). FIG. 6B. β-MyHC Peptide Standard Curve. The internal standard peptide was mixed with the β-MyHC peptide and subjected to MALDI-TOF MS. The samples spotted onto the MALDI plate contained 2 pmol of the internal standard peptide and 0-4 pmol of the β-MyHC peptide. The ion current ratio (β/IS) was measured and plotted against the amount of β-MyHC peptide. Each point represents the average of ten measurements and error bars represent standard deviations. Regression analysis indicated a linear relationship between ion current ratio (β/IS) and the amount of β-MyHC peptide (slope of 0.49 and r2=0.998).

FIG. 7—Linearity of the assay with protein amount. Aliquots of partially purified atrial myosin (patient 1) were electrophoresed on SDS gels with loads of 0, 1, 2, 3, and 4 micrograms of total protein. The MyHC band was excised and analyzed for the amounts of both the α- and β-MyHC isoforms by MALDI-TOF MS using the standard curves shown in FIG. 6. The amounts of α-MyHC and β-MyHC were graphed against the load of total protein. The assays were linear as indicated by regression analysis (r2=0.998 for α-MyHC, and r2=0.999 for β-MyHC).

### DETAILED DESCRIPTION OF ILLUSTRATIVE EMBODIMENTS

I. The Present Invention

Mass spectrometry (MS), because of its extreme selectivity and sensitivity, has become a powerful tool for the quantification of a broad range of bioanalytes including pharmaceuticals, metabolites, peptides and proteins. By exploiting the intrinsic properties of mass and charge, compounds can be resolved and confidently identified. However the signal generated by the compound will vary between runs due to differences in sample introduction, ionization process, ion acceleration, ion separation, and ion detection. Therefore any type of MS quantification will rely on internal standards that undergo the same processes as the analyte.

The present inventors have developed MALDI-TOF MS methods to accurately measure the amounts of proteins in samples, including the situation where multiple distinct proteins are present in the same sample. As an example, α- and β-MyHC protein amounts have been determined both relative to each other and with regard to absolute amounts of these related species. α-MyHC mRNA expression is down regulated in heart failure and β-MyHC mRNA expression is up regulated. These changes are reversed in patients successfully treated with adrenergic receptor blockers. This suggests that changes in MyHC protein expression are important for cardiac function, and provide a useful diagnostic and prognostic indicator. The isoforms are highly homologous and very difficult to distinguish by conventional means, yet are quite amenable to evaluation by the present invention.

From the studies illustrated herein, the inventors have demonstrated that highly homologous peptides, when present in the same sample, will produce MALDI-TOF MS signals that are proportional to the relative concentrations of those peptides, and thus can be used as accurate and sensitive internal standards for quantitation. This relationship holds for both linear and reflector modes of MALDI-TOF MS, as well as when signals are measured by peak intensity or peak area. MALDI-TOF MS can also be used to measure the relative amounts of closely related protein isoforms. Homologous peptides from the isoform can serve as internal standards for each other. MALDI-TOF MS can be used to measure the absolute concentrations of proteins as well. Synthetic peptides homologous to unique peptides from the proteins can be used as internal standards.

The details of the invention are described in the following pages.

II. Protein Compositions and Structure

A. Protein Compositions

In certain embodiments, the present invention concerns proteinaceous compositions and their use. As used herein, a “proteinaceous molecule,” “proteinaceous composition,” “proteinaceous compound,” “proteinaceous chain” or “proteinaceous material” generally refers (a) a protein which will be defined as a polypeptide of greater than about 100 amino acids, or (b) a peptide of from about 3 to about 100 amino acids. All the “proteinaceous” terms described above may be used interchangeably herein.

In certain embodiments the size of the peptide may comprise, but is not limited to, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, about 30, about 31, about 32, about 33, about 34, about 35, about 36, about 37, about 38, about 39, about 40, about 41, about 42, about 43, about 44, about 45, about 46, about 47, about 48, about 49, about 50, about 51, about 52, about 53, about 54, about 55, about 56, about 57, about 58, about 59, about 60, about 61, about 62, about 63, about 64, about 65, about 66, about 67, about 68, about 69, about 70, about 71, about 72, about 73, about 74, about 75, about 76, about 77, about 78, about 79, about 80, about 81, about 82, about 83, about 84, about 85, about 86, about 87, about 88, about 89, about 90, about 91, about 92, about 93, about 94, about 95, about 96, about 97, about 98, about 99, and about 100 residues.

Proteins will comprise at least about 101 residues, about 110, about 120, about 130, about 140, about 150, about 160, about 170, about 180, about 190, about 200, about 210, about 220, about 230, about 240, about 250, about 275, about 300, about 325, about 350, about 375, about 400, about 425, about 450, about 475, about 500, about 525, about 550, about 575, about 600, about 625, about 650, about 675, about 700, about 725, about 750, about 775, about 800, about 825, about 850, about 875, about 900, about 925, about 950, about 975, about 1000, about 1100, about 1200, about 1300, about 1400, about 1500, about 1750, about 2000, about 2250, about 2500 or greater amino molecule residues, and any range derivable therein.

As used herein, an “amino molecule” refers to any amino acid, amino acid derivative or amino acid mimic as would be known to one of ordinary skill in the art. In certain embodiments, the residues of the proteinaceous molecule are sequential, without any non-amino molecule interrupting the sequence of amino molecule residues. In other embodiments, the sequence may comprise one or more non-amino molecule moieties. In particular embodiments, the sequence of residues of the proteinaceous molecule may be interrupted by one or more non-amino molecule moieties. Accordingly, the term “proteinaceous composition” encompasses amino acid sequences comprising the 20 common amino acids, and may include one or more modified or unusual amino acid, including but not limited to those shown on Table 1 below.

An example of a method for chemical synthesis of such a peptide is as follows. Using the solid phase peptide synthesis method of Sheppard et al. (1981) an automated peptide synthesizer (Pharmacia LKB Biotechnology Co., LKB Biotynk 4170) adds N,N′-dicyclohexylcarbodiimide to amino acids whose amine functional groups are protected by 9-fluorenylmethoxycarbonyl groups, producing anhydrides of the desired amino acid (Fmoc-amino acids). An Fmoc amino acid corresponding to the C-terminal amino acid of the desired peptide is affixed to Ultrosyn A resin (Pharmacia LKB Biotechnology Co.) through its carboxyl group, using dimethylaminopyridine as a catalyst. The resin is then washed with dimethylformamide containing iperidine resulting in the removal of the protective amine group of the C-terminal amino acid. A Fmoc-amino acid anhydride corresponding to the next residue in the peptide sequence is then added to the substrate and allowed to couple with the unprotected amino acid affixed to the resin. The protective amine group is subsequently removed from the second amino acid and the above process is repeated with additional residues added to the peptide in a like manner until the sequence is completed. After the peptide is completed, the protective groups, other than the acetoamidomethyl group are removed and the peptide is released from the resin with a solvent consisting of, for example, 94% (by weight) trifluroacetic acid, 5% phenol, and 1% ethanol. The synthesized peptide is subsequently purified using high-performance liquid chromatography or other peptide purification technique discussed below.

TABLE 1
Modified and Unusual Amino Acids

| Abbr. | Amino Acid |
|---|---|
| Aad | 2-Aminoadipic acid |
| Baad | 3- Aminoadipic acid |
| Bala | β-alanine, |
| | β-Amino-propionic acid |
| Abu | 2-Aminobutyric acid |
| 4Abu | 4- Aminobutyric acid, |
| | piperidinic acid |
| Acp | 6-Aminocaproic acid |
| Ahe | 2-Aminoheptanoic acid |
| Aib | 2-Aminoisobutyric acid |
| Baib | 3-Aminoisobutyric acid |
| Apm | 2-Aminopimelic acid |
| Dbu | 2,4-Diaminobutyric acid |
| Des | Desmosine |
| Dpm | 2,2′-Diaminopimelic acid |
| Dpr | 2,3-Diaminopropionic acid |
| EtGly | N-Ethylglycine |
| EtAsn | N-Ethylasparagine |
| Hyl | Hydroxylysine |
| AHyl | allo-Hydroxylysine |
| 3Hyp | 3-Hydroxyproline |
| 4Hyp | 4-Hydroxyproline |
| Ide | Isodesmosine |
| AIle | allo-Isoleucine |
| MeGly | N-Methylglycine, |
| | sarcosine |
| MeIle | N-Methylisoleucine |
| MeLys | 6-N-Methyllysine |
| MeVal | N-Methylvaline |
| Nva | Norvaline |
| Me | Norleucine |
| Orn | Ornithine |

Proteinaceous compositions may also be made by genetic means, i.e., expression of proteins through standard molecular biological techniques, or by the isolation of proteinaceous compounds from natural sources (optionally followed by degradative treatment). The nucleotide and protein, polypeptide and peptide sequences for various genes have been previously disclosed, and may be found at computerized databases known to those of ordinary skill in the art. One such database is the National Center for Biotechnology Information's Genbank and GenPept databases (www.ncbi.nlm.nih.gov). The coding regions for these known genes may be amplified and/or expressed using the techniques disclosed herein or as would be know to those of ordinary skill in the art. Alternatively, various commercial preparations of proteins, polypeptides and peptides are known to those of skill in the art.

In certain embodiments a proteinaceous compound may be purified. Generally, “purified” will refer to a specific or protein, polypeptide, or peptide composition that has been subjected to some degree fractionation to remove various other molecules, such as lipids, nucleic acids or proteins or peptides. The purification generally is best when it permits retention of protein structure (discussed below). Any of a wide variety of chromatographic procedures may be employed. For example, thin layer chromatography, gas chromatography, high performance liquid chromatography, paper chromatography, affinity chromatography or supercritical flow chromatography may be used to effect separation of various chemical species away from the proteins or peptides of the present invention.

B. Protein Structure

Primary structure of peptides and proteins is the linear sequence of amino acids that are bound together by peptide bonds. A change in a single amino acid in a critical area of the protein or peptide can alter biologic function as is the case in sickle cell disease and many inherited metabolic disorders. Disulfide bonds between cysteine (sulfur containing amino acid) residues of the peptide chain stabilize the protein structure. The primary structure specifies the secondary, tertiary and quaternary structure of the peptide or protein.

Secondary structure of peptides and proteins may be organized into regular structures such as an alpha helix or a pleated sheet that may repeat, or the chain may organize itself randomly. The individual characteristics of the amino acid functional groups and placement of disulfide bonds determine the secondary structure. Hydrogen bonding stabilizes the secondary structure.

Genomic information does not predict post-translational modifications that most proteins undergo. After synthesis on ribosomes, proteins are cut to eliminate initiation, transit and signal sequences and simple chemical groups or complex molecules are attached. Post-translational modifications are numerous (more than 200 types have been documented), static and dynamic including phosphorylation, glycosylation and sulfation.

Tertiary structure of proteins and peptides is the overall 3-D conformation of the complete protein. Tertiary structure considers the steric relationship of amino acid residues that may be far removed from one another in the primary structure. Such a 3-D structure is that which is most thermodynamically stable for a given environment and is often subject to change with subtle changes in environment. In vivo, folding of large multidomain proteins occurs cotranslationally and the maturation of proteins occurs in seconds or minutes. Intracellular protein folding is regulated by cellular factors to prevent improper aggregation and facilitate translocation across membranes. The two methods for determining 3-D protein structures are nuclear magnetic resonance and x-ray crystallography.

If the functional protein comprises several subunits, the quaternary structure consists of the conformation of all the subunits bound together by electrostatic and hydrogen bonds. Multisubunit proteins are called oligomers and the various component parts are each monomers or subunits.

II. Quantitative Mass Spectrometry

Mass spectrometry (MS), because of its extreme selectivity and sensitivity, has become a powerful tool for the quantification of a broad range of bioanalytes including pharmaceuticals, metabolites, peptides and proteins. By exploiting the intrinsic properties of mass and charge, compounds can be resolved and confidently identified. However the signal generated by the compound will vary between runs due to differences in sample introduction, ionization process, ion acceleration, ion separation, and ion detection. Therefore any type of MS quantification will rely on internal standards that undergo the same processes as the analyte. Traditional quantitative MS has used electrospray ionization (ESI) followed by tandem MS (MS/MS) (Chen et al., 2001; Zhong et al., 2001; Wu et al., 2000) while newer quantitative methods are being developed using matrix assisted laser desorption/ionization (MALDI) followed by time of flight (TOF) MS (Bucknall et al., 2002; Mirgorodskaya et al., 2000; Gobom et al., 2000).

The ESI/MS/MS method uses triple quadrupole instruments, which are capable of fragmenting precursor ions into product ions. By simultaneously analyzing both precursor ions and product ions, a single precursor product reaction is monitored and this selective reaction monitoring (SRM) produces a signal only when the desired precursor ion is present. When the internal standard is a stable isotope labeled version of the analyte this is known as quantification by the stable isotope dilution method. This approach is used to accurately measure pharmaceuticals (Zhang et al., 2001; Zweigenbaum et al., 2000; Zweigenbaum et al., 1999) and bioactive peptides (Desiderio et al., 1996; Zhu et al., 1995; Lovelace et al., 1991). The newer method is done on widely available MALDI-TOF instruments, which can resolve a wider mass range and have been used to quantify metabolites, peptides, and proteins. Complex mixtures such as crude extracts can be analyzed but in some instances sample clean up is required (Nelson et al., 1994; Gobom et al., 2000). Stable isotope labeled peptides have been used as internal standards (Gobom et al., 2000; Mirgorodskaya et al., 2000). However, it has been shown that while stable isotope labeled standards are required for small molecules, larger molecules such as peptides can be quantified using unlabeled homologous peptides as long as their chemistry is similar to the analyte peptide (Duncan et al., 1993; Bucknall et al., 2002). Protein quantification has been achieved by quantifying tryptic peptides (Mirgorodskaya et al., 2000).

Measurements of eukaryotic mRNA and protein concentrations correlate poorly (Anderson et al., 1997; Gygi et al., 1999), and this has also been specifically shown for proteins such as myosin heavy chain (MyHC) and actin in human heart tissue (dos Remedios et al., 1996). Further evidence is found in measurements of isoform ratios. In the adult human heart, the mRNA for α-MyHC was about 30% of total cardiac MyHC mRNA (Lowes et al., 1997) but α-MyHC protein was about 3-7% (Miyata et al., 2000; Reiser et al., 2001) of total cardiac MyHC protein. The S actin mRNA was about 60% of total actin mRNA (Boheler et al., 1991) but S actin protein was about 20% of total actin protein (Vendekerckhove et al., 1986). These results emphasize that protein concentrations and ratios cannot be inferred from mRNA concentrations. Therefore as life science moves from measuring mRNA to measuring protein, this type of MS methodology has the potential to become a powerful tool for the sensitive and precise quantification of protein.

III. MALDI-TOF-MS

Since its inception and commercial availability, the versatility of MALDI-TOF-MS has been demonstrated convincingly by its extensive use for qualitative analysis. For example, MALDI-TOF-MS has been employed for the characterization of synthetic polymers (Marie et al., 2000; Wu et al., 1998). peptide and protein analysis (Zuluzec et al., 1995; Roepstorff et al., 2000; Nguyen et al., 1995), DNA and oligonucleotide sequencing (Miketova et al., 1997; Faulstich et al., 1997; Bentzley et al., 1996), and the characterization of recombinant proteins (Kanazawa et al., 1999; Villanueva et al., 1999). Recently, applications of MALDI-TOF-MS have been extended to include the direct analysis of biological tissues and single cell organisms with the aim of characterizing endogenous peptide and protein constituents (Li et al., 2000; Lynn et al., 1999; Stoeckli et al., 2001; Caprioli et al., 1997; Chaurand et al., 1999; Jespersen et al., 1999).

The properties that make MALDI-TOF-MS a popular qualitative tool-its ability to analyze molecules across an extensive mass range, high sensitivity, minimal sample preparation and rapid analysis times-also make it a potentially useful quantitative tool. MALDI-TOF-MS also enables non-volatile and thermally labile molecules to be analyzed with relative ease. It is therefore prudent to explore the potential of MALDI-TOF-MS for quantitative analysis in clinical settings, for toxicological screenings, as well as for environmental analysis. In addition, the application of MALDI-TOF-MS to the quantification of peptides and proteins is particularly relevant. The ability to quantify intact proteins in biological tissue and fluids presents a particular challenge in the expanding area of proteomics and investigators urgently require methods to accurately measure the absolute quantity of proteins. While there have been reports of quantitative MALDI-TOF-MS applications, there are many problems inherent to the MALDI ionization process that have restricted its widespread use (Kazmaier et al., 1998; Horak et al., 2001; Gobom et al., 2000; Wang et al., 2000; Desiderio et al., 2000). These limitations primarily stern from factors such as the sample/matrix heterogeneity, which are believed to contribute to the large variability in observed signal intensities for analytes, the limited dynamic range due to detector saturation, and difficulties associated with coupling MALDI-TOF-MS to on-line separation techniques such as liquid chromatography. Combined, these factors are thought to compromise the accuracy, precision, and utility with which quantitative determinations can be made.

Because of these difficulties, practical examples of quantitative applications of MALDI-TOF-MS have been limited. Most of the studies to date have focused on the quantification of low mass analytes, in particular, alkaloids or active ingredients in agricultural or food products (Wang et al., 1999; Jiang et al., 2000; Wang et al., 2000; Yang et al., 2000; Wittmann et al., 2001), whereas other studies have demonstrated the potential of MALDI-TOF-MS for the quantification of biologically relevant analytes such as neuropeptides, proteins, antibiotics, or various metabolites in biological tissue or fluid (Muddiman et al., 1996; Nelson et al., 1994; Duncan et al., 1993; Gobom et al., 2000; Wu et al., 1997; Mirgorodskaya et al., 2000). In earlier work it was shown that linear calibration curves could be generated by MALDI-TOF-MS provided that an appropriate internal standard was employed (Duncan et al., 1993). This standard can “correct” for both sample-to-sample and shot-to-shot variability. Stable isotope labeled internal standards (isotopomers) give the best result.

With the marked improvement in resolution available on modern commercial instruments, primarily because of delayed extraction (Bahr et al., 1997; Takach et al., 1997), the opportunity to extend quantitative work to other examples is now possible; not only of low mass analytes, but also biopolymers. Of particular interest is the prospect of absolute multi-component quantification in biological samples (e.g., proteomics applications).

The properties of the matrix material used in the MALDI method are critical. Only a select group of compounds is useful for the selective desorption of proteins and polypeptides. A review of all the matrix materials available for peptides and proteins shows that there are certain characteristics the compounds must share to be analytically useful. Despite its importance, very little is known about what makes a matrix material “successful” for MALDI. The few materials that do work well are used heavily by all MALDI practitioners and new molecules are constantly being evaluated as potential matrix candidates. With a few exceptions, most of the matrix materials used are solid organic acids. Liquid matrices have also been investigated, but are not used routinely.

A. Sample Preparation

In general, all reasonable efforts should be made to reduce excessive contamination in the samples. Always use the best quality solvents, reagents and samples. HPLC-grade solvents should be the standard in MALDI experiments. Keep all samples in plastic containers. Glass containers can cause irreversible sample losses through adsorption on the walls, and release alkali metals into the analyte solution.

Optimum sample handling conditions for biological preparations usually involve non-volatile salts. Desalting might be necessary in the presence of excessive cationization, decreased resolution or signal suppression. Washing the analyte-doped matrix crystals with cold acidic water has been suggested as a very efficient way of desalting samples that have already been crystallized with the matrix. However, whenever possible, it is best to remove the salts, before the crystals are grown, using some of the techniques described later. There is a competition between protonation and cationization in MALDI when salts are present, and the choice between the two processes is still the subject of investigation.

When working with complex biological materials in MALDI it is often necessary to use detergents, otherwise the proteins, specially at <mM concentrations, will be rapidly adsorbed on accessible surfaces. If no detergent is used, agglomeration and adsorption can effectively suppress protein peaks in the spectrum. The effect of detergents on MALDI spectra depends on the type of detergent and sample.

Nonionic detergents (TritonX-100, Triton X-114, N-octylglucoside and Tween 80) do not interfere significantly with sample preparation. In fact, it has even been reported that Triton X-100, in a concentration up to 1%, is compatible with MALDI and in some cases it can improve the quality of spectra. N-octylglucoside has been shown to enhance the MALDI-MS response of the larger peptides in digest mixtures. The addition of nonionic detergents is often a requirement for the analysis of hydrophobic proteins. Common detergents such as PEG and Triton, added during protein extraction from cells and tissues, desorb more efficiently than peptides and proteins and can effectively overwhelm the ion signals. Detergents often provide good internal calibration peaks in the low mass range of the mass spectrum.

Ionic detergents and particularly sodium dodecyl sulfate (SDS), can severely interfere with MALDI even at very low concentrations. Concentrations of SDS above 0.1% must be reduced by sample purification prior to crystallization with the matrix. The seriousness of this effect cannot be ignored given the wide application of MALDI to the analysis of proteins separated by SDS-PAGE. Polyacrylamide gel electrophoresis introduces sodium, potassium and SDS contamination to the sample, and it also reduces the recovered concentration of analyte. Once a protein has been coated with SDS, simply removing the excess SDS from the solution will not improve sample prep for MALDI: the SDS shell must also be removed. Typical purification schemes involve two phase extraction such as reversed-phase chromatography or liquid-liquid extraction. The removal of SDS from protein samples prior to MALDI mass spectrometry is an important issue.

Involatile solvents are often used in protein chemistry. Examples are: glycerol, polyethyleneglycol, β-mercaptoethanol, dimethyl sulfoxide (DMSO) and dimethylformamide (DMF). These solvents interfere with matrix crystallization and coat any crystals that do form with a difficult to remove solvent layer. If you must use these solvents and the dried-droplet method does not yield good results, try a different crystallization technique such as crushed-crystal method.

The use of buffers is often necessary in protein sample preparation to maintain biological activity and integrity. It is generally assumed that MALDI is tolerant of buffers. In cases where buffers are possible sources of interference, a trick that has been shown to work is to increase the matrix:analyte ratio. The effect of six common buffer systems, on the MALDI spectra of bovine insulin, cytochrome c and bovine albumin with DHB as a matrix has been studied (Wilkins et al., 1998).

In order to get “clean samples,” free of salts, buffers, detergents and involatile compounds, several experimental approaches have been tested with varying results. A number of researchers have attempted to establish “MALDI from synthetic membranes” as a general purification tool in protein biochemistry. In an extensive series of experiments, analyte droplets were deposited on to polymeric membranes (porous polyethylene, polypropylene, analyte, nylon, Nafion, and others), washed in special solvents, and mixed with matrix to provide “clean” crystals. The approach is most useful for the direct analysis of proteins electroblotted from SDS-PAGE gels into synthetic membranes. In a more elaborate experiment, protein samples were desalted and freed of salts and detergents by constructing self-assembled monolayers of octadecylmercaptan (C 18) on a gold coated MALDI probe surface. These surfaces were able to reversibly bind polypeptides through hydrophobic interactions allowing simultaneous concentration and desalting of the analyte.

Surface enhanced affinity capture (SEAC) was created (Hutchens et al., 1993) to facilitate the desorption of specific macromolecules affinity-captured directly from unfractionated biological fluids and extracts, and can also be used as a means for sample purification. Direct analysis of affinity-bound analytes by MALDI TOF is now performed routinely and it is even possible to get customized affinity-capture sample probes from commercial sources.

Purification of analyte samples by traditional methods, such as alcohol or acetone precipitation, HPLC, ultrafiltration, liquid-liquid extraction, dialysis and ion exchange are always recommended; however, the effects of increased sample preparation time and sample recovery yields must be weighed carefully. It is possible to purify samples prior to analysis by using small, commercially available (or even home-made) C18 reverse-phase microcolumns or centrifugal ultrafiltration devices; however, such devices can still suffer from the same drawbacks as large scale separation schemes. Note that acetone precipitation and dialysis usually do not remove enough detergent for MALDI sample preparation.

The degradation of signal intensity and resolution that results from excessive contamination can sometimes be eliminated by more extensive dilution of the protein in the matrix solution, a common trick is to try a 1:5 dilution series of the sample. Diluting the protein solution very often improves the MALDI signal, perhaps by diluting the contaminants while the matrix concentrates the analyte. This trick works well for hydrophobic proteins where the presence of lipids is suspected.

B. Matrix

Solubility in commonly used protein solvent mixtures is one of the conditions a “good” matrix must meet. Incorporating the protein or peptide (target or standard) into a growing matrix crystal implies that the protein and the matrix must be simultaneously in solution. Therefore, a matrix should dissolve and grow protein-doped crystals in commonly used protein-solvent systems. This condition should be expanded to any solvent system in which the analyte of interest will co-dissolve with the matrix. In practical terms, this means that the matrix must be sufficiently soluble to make 1-100 mM solutions in solvent systems consisting of: acidified water, water-acetonitrile mixtures, water-alcohol mixtures, 70% formic acid, etc.

The light absorption spectrum of the matrix crystals must overlap the frequency of the laser pulse being used. The laser pulse energy must be deposited in the matrix. Unfortunately the absorption coefficients of solid systems are not easily measured and are usually red shifted (Stokes shift) relative to the values in solution. The extent of the shifts varies from compound to compound. The solution absorption coefficients are often used as a guide, and typical ranges for commonly used matrix materials, at the wavelengths they are applied, are e=3000-16000 (1 mol-1 cm⁻¹). UV-MALDI, with compact and inexpensive nitrogen lasers operating at 337 nm is the most common instrumental option for the routine analysis of peptides and proteins. IR-MALDI of peptides has been demonstrated but is not used in analytical applications. For UV-MALDI, compounds such as some trans-cinnamic acid derivatives and 2,5-dihydroxy benzoic acid have proven to give the best results.

The intrinsic reactivity of the matrix material with the analyte must also be considered. Matrices that covalently modify proteins (or any other analyte) cannot be applied. Oxidizing agents that can react with disulfide bonds and cysteine groups and methionine groups are immediately ruled out. Aldehydes cannot be used because of their reactivity with amino groups.

The matrix material must demonstrate adequate photostability in the presence of the laser pulse illumination. Some matrices become unstable, and react with the peptides, after laser illumination. Nicotinic acid, for example, easily looses; —COOH when photochemically excited leaving a very reactive pyridyl group which results in several pyridyl adduct peaks in the spectrum. This is one of the reasons that the use of nicotinic acid has been replaced by more stable matrices such as SA and CHCA.

The volatility of the matrix material must be contemplated as well. From an instrumental perspective, the matrix crystals must remain in vacuum for extended periods of time without subliming away. Cinnamic acid derivatives perform a lot better in that respect when compared to nicotinic and vanillic acids.

The matrix must have a special affinity for analytes that allows them to be incorporated into the matrix crystals during the drying process. This is undoubtfully the hardest property to quantify and impossible to predict. In the current view of MALDI sample preparation, ion production in the solid-state source depends on the generation of a suitable composite material, consisting of the analyte and the matrix. As the solvent evaporates, the analyte molecules are effectively and selectively extracted from the mother liquor and co-crystallyzed with the matrix molecules. Impurities and other necessary solution additives are naturally excluded from the process.

The matrix molecules must possess the appropriate chemical properties so that analyte molecules can be ionized. Most of the energy from the laser is absorbed by the matrix and results in a rapid expansion from the solid to the gas phase. Ionization of the analyte is believed to occur in the high pressure region just above the irradiated surface and may involve ion-molecule reactions or reaction of excited state species with analyte molecules. Most commonly used matrix materials are organic acids and protonation, the addition of a proton to the analyte molecule to form (M+H)+ions, is the most common ionization mechanism in MALDI of peptides and proteins. Excited state proton transfer is a plausible mechanism for the charge transfer events that occur in the plume. Compounds, which perform a proton transfer under UV irradiation, are generally usable as matrices for UV-MALDI-MS. Whether the described proton transfer and the resulting metastable excited-state is involved in the ionization process or if it just offers an absorption band in the used wavelength area is not clear.

The final and definitive test for any potential matrix compound is to introduce the material in a laser desorption mass spectrometer and do a MALDI experiment. Many compounds form protein-doped structures that produce protein ions, but they are disqualified by other factors. The qualities that separate most matrix candidates from the ones that actually work are still very obscure and more studies are needed to improve the understanding of the effects involved.

Once a matrix compound has been proved to deliver ions in a MALDI source, it is also important to look at the performance of the material as far as the extent of matrix adduction to the analyte ions. Matrix adduct ions, (M+matrix+H)+, are usually observed in MALDI spectra; however, extensive adduct formation affects the ability to determine accurate molecular weights when the adductions are not well resolved from the parent peak. The best matrices have low intensity photo chemical adduct peaks.

MALDI is a soft ionization method capable of ionizing very large bioplymers while producing little or no fragmentation. The extent of fragmentation during desorption/ionization must be considered critically during matrix selection. Excessive fragmentation can cause decreased resolution. It is well known that the extent of fragmentation for proteins is strongly related to the matrix compound used. Some matrices are “hotter” than others, leading to more in-source (i.e., prompt) and post-source decay. A good example of a “hot” matrix material is CHCA which produces intense multiply charged ions in the positive ion spectra of proteins and contributes to significant fragmentation in the mass spectrometer.

Even after a matrix has been proved to be useful for a specific peptide or protein there is no algorithm other than trial-and-error to predict its applicability to other sample molecules. More than one matrix material is often required to get a complete representation of a complex mixture.

With a few exceptions, the development of new matrices has relied completely on commercially available compounds. It has been argued that this has limited the ability to effectively correlate matrix structure to MALDI function. More recent efforts (Brown et al., 1997), have tried to overcome this limitation through the intelligent synthesis of compounds that will provide a wide range of functionality. Most fine chemical manufacturers are aware of the utility of some of their compounds as MALDI matrices and have dedicated catalog numbers to those chemicals purified specifically for MALDI application. Matrix compounds are typically used as received from the manufacturer without any prior purification, and it is always a good idea to store them in the dark.

Most MALDI practitioners use MALDI for pure analytical purposes and are not interested in the discovery of novel MALDI materials. Luckily for them, there are a few compounds that provide consistently good results and can be relied upon for the routine analysis of peptides and proteins. S of the most commonly used matrices are α-cyano-4-hydroxycinnamic acid (CHCA), gentisic acid, or 2,5-dihydroxy benzoic acid (DHB), trans-3-indoleacrylic acid (IAA), 3-hydroxypicolinic acid (HPA), 2,4,6-trihydroxyacetophenone (THAP), dithranol (DIT). The definitive choice of matrix material depends on the type of analyte, its molecular weight and the nature of the sample (pure compound, mixture or raw biological extract). In all cases the performance of the matrix material is influenced by the choice of solvent. Experimentation (i.e., trial-and-error laced with a few educated guesses) is generally the only way to find the best sample preparation conditions. Some examples of compounds that have also been used for MALDI of peptides and proteins include: hydroxy-benzophenones, mercaptobenthothiazoles, b-carbolines and even high explosives.

Most matrices reported to date are acidic, but basic matrices such as 2-amino-4-methyl-5-nitropyridine and neutral matrices such as 6-aza-2-thiothymine (ATT) are also used, which extends the utility of MALDI to acid sensitive compounds.

Matrix peaks are often used for low mass calibration in the mass axis calibration procedure. [M+Na]+ and [M+K]+peaks are also observed if samples are not carefully desalted.

1. Matrix Suppression

At appropriate matrix to analyte mixing ratios, small to moderately sized analyte ions (1000-20000 Da) can fully suppress positively charged matrix ions in MALDI mass spectra. This is true for all matrix species, and is observed regardless of the preferred analyte ion form (protonated or cationized). Since the effect has been observed with a number of matrices including CHCA and DHB, it seems to be a general phenomenon in MALDI. Along with the fact that fragmentation is weak in MALDI, this leads to nearly ideal mass spectra with a strong peak for the analyte ions and no other signals present.

2. Co-Matrices (Matrix Additives)

Several additives have been added to MALDI samples to enhance the quality of the mass spectra. Additives, also known as co-matrices, can serve several different purposes: (1) increase the homogeneity of the matrix/analyte deposit, (2) decrease/increase the amount of fragmentation, (3) decrease the levels of cationization, (4) increase ion yields, (5) increase precision of quantitation, (6) increase sample-to-sample reproducibility, and (7) increase resolution.

The use of co-matrices is much more widespread in the analysis of oligonucleotides, where ammonium salts and organic bases are very common additives. Some MALDI researchers believe that the use of additives may provide the most general and simplest means of improving the current matrix systems. Continuing efforts are needed to evaluate the effects of co-matrices on the MALDI process, and to further characterize additives for such purposes. Some examples of additives used in peptide and protein measurements are: common matrices, bumetamide, glutathione, 4-nitroaniline, vanillin, nitrocellulose and L(−) fucose.

The addition of ammonium salts to the matrix/analyte solution substantially enhances the signal for phosphopeptides. This has been used to allow the identification of phosphopeptides from unfractionated proteolytic digests. The approach works well with CHCA and DHB and with ammonium salts such as diammonium citrate and ammonium acetate.

C. Solvent Selection

Solvent choice remains to this day a trial-and-error process that is governed by the need to maintain analyte solubility and promote the partitioning of the analyte into the matrix crystals during drying of the analyte/matrix solution. As a general rule, it is best to first find the appropriate solvent for the sample.

Once the analyte has been completely dissolved, a solvent should be chosen for the matrix that is miscible with the analyte solvent. In some cases, such as the analysis of peptides and proteins, or oligonucleotides, the appropriate solvents are well known. In the analysis of peptides/proteins 0.1% TFA is the solvent of choice, and for oligonucleotides, pure 18 Ohm water. The matrices for these analytes are dissolved in ACN/0.1% TFA and ACN/H₂O, respectively. What follows is a more detailed look at the rules governing the choice of solvents for analyte and matrices in MALDI.

Solubility of the analyte in the solvent system is one of the most important parameters to be considered during solvent selection. The analyte must be truly dissolved in the solvent at all times. Making a slurry of analyte powder and solvent never leads to good results.

Two solvent systems are usually involved in a MALDI sample preparation procedure. There is a solvent system for the analyte sample, and a different solvent for the matrix. In most sample preparation recipes (dried-droplet technique), an aliquot of the matrix solution is mixed with an aliquot of the protein solution to make a crystal-forming mother liquor. Both matrix and analyte solvents must be chosen carefully. It is important that neither the matrix nor the analyte precipitate when the two solutions mix. Particular care must be taken when the analyte's solvent does not contain any organic solvent, which may lead to precipitation of the matrix during mixing. Attention must also be paid to inadvertent changes in solvent composition as caused by selective evaporation of organic solvents from aqueous solutions. Tubes of analyte and matrix solutions should be kept closed while not in use to avoid evaporation.

Analyte solubilization is the key to the successful analysis of hydrophobic proteins and peptides. Owing to their limited solubility in aqueous solvents, alternative solvents for both the matrix and the analyte have been carefully investigated. Several solubilization schemes have been successfully applied including strong organic acids (i.e., formic acid), detergent solutions and non-polar organic solvents. Non-ionic detergents, that improve the solubility of peptides and proteins, are often added to sample solutions to improve the quality of spectra. The effect has been reported in the literature for the characterization of high molecular weight proteins in very dilute solutions. Use of detergents for cell profiling has extended the detectable mass range to about 75 kDa.

The surface tension of the solvent system must also be considered during the selection process. At low surface tension the matrix-analyte droplets spread over a large surface area resulting in a dilution effect and lowering the ion yields. In general, water-rich solvents exhibit adequate surface tension and allow the formation of reproducible round-shaped deposits with high crystal density. Low surface tension solvents, such as alcohols and acetone, provide wide spread and irregularly shaped crystal beds. Careful adjustment of the solvent surface tension is needed for MALDI targets with closely spaced sample wells and for sample preparation procedures relying on robotic sample loading.

The volatility of the solvent must also be considered. Fast solvent evaporation results in smaller crystals with more homogeneous analyte distributions. However, rapid crystallization also shows increased cationization, favors low molecular weight components in mixtures and provides very thin crystal beds that can only handle a few laser shots per spot. Volatile solvents require more skill from the operator since they must be handled quickly to avoid premature precipitation of the matrix in the pipette tips as caused by excessive solvent evaporation. Fast evaporating solvents such as acetone and methanol have reduced surface tension and form very wide and irregularly shaped MALDI deposits. The use of volatile solvents to obtain microcrystals during sample preparation can often be substituted with the “acetone redeposition technique. In this technique, the dried MALDI sample (prepared with non-volatile solvents) is dissolved in a single drop of acetone and, as the acetone evaporates, the sample crystallizes to form a more homogeneous film.

Involatile solvents commonly used in protein chemistry must be avoided. Examples are glycerol, polyethyleneglycol, b-mercaptoethanol, dimethylsulfoxide, and dimethylformamide. These solvents interfere with matrix crystallization and coat any crystals that do form with a difficult to remove solvent layer. The crushed crystal method was specifically developed to deal with their presence.

The pH of the evaporating solvent system must be less than 4. Most of the MALDI matrix materials used for peptides and proteins are organic acids that become ions at pH>4, completely changing their crystallization properties. Solvent acidity affects the protein binding to matrix crystals and it can even modify the conformation of the proteins. Analyte conformation has been shown to influence MALDI Ion yields. The addition of trifluoroacetic acid (TFA) and formic acid (FA) to matrix solutions is common practice to assure the correct acidity during evaporation of the analyte-matrix droplet. Another common trick is to use 0.1% and 1% TFA, instead of pure water, as protein sample solvents. The acidity of the solution must be carefully optimized in MALDI of mixtures to assure no components are being excluded from the crystals.

The reactivity of the solvent system with the analyte must be contemplated. A common problem of using strongly acidic solvents is cleavage of acid-labile peptide bonds, such as aspartic acid's proline bond. Cleavage of this bond in small and large proteins has been observed after sample preparation and cleavage products increase in intensity with time.

A potential problem with using formic acid as a solvent, or solvent component, is its reactivity toward serine and threonine residues in proteins. Formyl esterification of those amino acids results in the production of satellite peaks at 28 Da intervals of higher molecular weight. As a result, exposure to formic acid should be avoided in any experiments using exact mass measurements. If the procedure must use formic acid, exposure should be kept as short as possible. Formic acid, 70%, is the best solvent for CNBr peptide cleavage. Dilute HCl (0.1 N) may also be used; however, care must be taken to neutralize the solution's pH before evaporating the solvent to dryness. A protocol has been reported for deformylation of formylated peptides generated during CNBr cleavage by treatment with ethanolamine (Tan et al., 1983). Concentrated TFA is also known to react with free amino acids.

The composition of the solvent is an important parameter that can influence the outcome of a MALDI experiment. The selection of solvent components is affected by the analyte type and its molecular weight and by the matrix material being used. The solvent system must be capable of dissolving the matrix and the analyte at the same time. It must also allow for the selective inclusion of the analyte into the matrix crystals during the drying process.

Hydrophilic peptides and protein samples are usually dissolved in 0.1% TFA. Matrices are often dissolved, at higher concentrations, in solvent systems consisting of up to three components. Common matrix solvent components are acetonitrile (CH3CN), small alcohols (methanol, ethanol 2-propanol), formic acid, dilute TFA (0.1-1% v/v) and pure water. TFA seems to yield spectra with higher mass resolution than formic acid; however, and particularly for mixtures, it is always advisable to try a range of solvents.

Oligonucleotides are mostly dissolved in pure water. Although, it is advised in all cases to use HPLC-graded solvents, deionized H₂O is recommended in the case of oligonucleotides. This is due to the fact that HPLC-grade water is acidic and can contain variable concentration of salts. The solvent most commonly used for HPA and THAP (oligonucleotide matrices) is a 1:1 v/v of ACN/H₂O. The additive that is used with these matrix solutions, ammonium bicitrate, is either dissolved in H₂O and later mixed with the matrix solutions or the matrices are dissolved in a solution of ammonium bicitrate in ACN/H₂₀.

In the analysis of organic molecules or polymers, it is important to first find the optimum solvent for the sample and from there, depending on what the appropriate matrix for that compound is, the matrix can be dissolved in the same solvent as the sample or in a solvent that is miscible with the analyte solution.

Hydrophobic peptides (not soluble in water) are dissolved in water-free systems such as chloroform/alcohol or formic acid/alcohol mixtures and the matrix is usually dissolved in the same or very similar solvent. A nonionic detergent is often added to improve solubility and ion yields.

Solvent proportions in a solvent mixture can affect the ion yields in a MALDI experiment. A complete sample preparation protocol should include optimization of the relative concentrations of solvents in a mixture. For example, it has been demonstrated that small variations in the water content of alcohol-Water mixtures can significantly affect ion yields. Very often the choice of concentrations can be as critical as the choice of components.

The variety of choices and effects that MALDI users must consider during solvent optimization must not be considered as a drawback for the MALDI technique. It is in fact, the ability to operate with a wide range of solvents and in the presence of impurities that has allowed MALDI to be used for the mass spectrometric characterization of all kinds of biological and synthetic polymers.

D. Substrate Selection

When designing effective MALDI sample preparation methods for analysis, attention must be given to the interaction of analytes with the substrate.

Most MALDI samples are prepared on and desorbed/ionized from multi-well metallic sample-plates made out of vacuum compatible stainless steel or aluminum. The role of the metal substrate in the desorption/ionization process is not well understood, but the surface conductivity of the metal is often considered essential to preserve the integrity of the electrostatic field around the sample during ion ejection. The hard metals can be machined and formed to high precision, and can also be easily cleaned and polished to provide the smooth surfaces needed for high resolution and high mass accuracy. The analyte/matrix crystals strongly adhere to metal surfaces providing very rugged samples that can be stored for long periods of time and washed for purification purposes.

Both stainless steel and aluminum are chemically inert to the matrix systems used and do not contribute metal ions to the cationization of the analyte during ion formation. Copper as a substrate, on the other hand, has been demonstrated to form adducts with both matrix and analyte during desorption (Russell et al., 1999). The effect is particularly dramatic with the matrix CHCA and leads to several peaks at molecular weights above the protonated ions. The extra peaks are generally viewed as a problem for the analysis of proteins, particularly when they are not clearly resolved from the protonated ion signal. However, Cu adduction can be exploited in MALDI post-source decay studies because [M+Cu]+ions fragment in ways different from the protonated ones, providing valuable extra sequencing information.

Most MALDI sources use a solid sample plate and irradiation is done from the front (reflection geometry); however, use of transmission geometry to desorb the analyte/matrix samples is possible. In the transmission geometry the laser irradiation and the mass spectrometer's analyzer are on opposite sides of the thin sample. The substrates used in the two case studies were quartz and plastic-coated grids (Formvar on zinc or copper).

Plastic is the second most common material used in MALDI sources as a substrate. Significant attention must be given to the interaction of the peptides and proteins with the polymeric surface. (Kinsel et al., 1999) The influence of polymer surface-protein binding affinity on protein ion signals has been studied, and it showed that as the surface-protein binding affinity increases the efficiency of MALDI of the protein decreases.

Desorption of high mass proteins (>100 kDa), directly deposited on polyethylene membranes was demonstrated (Blackledge et al., 1995) and the spectra obtained were identical or better than with standard metal substrates. Similar improvements were observed by Guo (1999) while desorbing DNA and proteins directly from Teflon-coated MALDI probes. The use of a Nafion substrate with certain matrices can significantly enhance the signals obtained over those observed with a stainless-steel probe. Its use has been demonstrated to be particularly effective in analyzing real biological mixtures without pre-purification and used with polypropylene, polystyrene, teflon, nylon, glass and ceramics as matrix crystal supports with no noticeable decrease in performance relative to all-metal constructions. (Hutchens et al, 1993).

The use of plastic membranes as sample supports has recently been adopted as a means of both sample purification and sample delivery into the mass spectrometer. If the analyte can be selectively adsorbed (hydrophobic interactions) onto the membrane, interfering substances can be washed off while the analyte is retained. Purification by on-probe washing results in lower sample loss than pre-purification by traditional methods. Polyethylene and polypropylene surfaces have been used to conduct on-probe sample purification. (Woods et al., 1998) Similarly, poly(vinylidene fluoride) based membranes have been used to extract and purify proteins from bulk cell extracts and for the removal of detergents, and a method has been developed for probe surface derivatization to construct monolayers of C18 on MALDI Probes (Orlando et al., 1997). Non-porous polyurethane membrane has been used as the collection device and transportation medium of blood sample analysis, followed by direct desorption from the same membrane substrate in a MALDI-TOF spectrometer (Perreault et al., 1998). Sample purification and proteolytic digest right on the probe tip, with minimal sample loss, was also possible with this substrate. Nitrocellulose, used as a sample additive or as a pre-deposited substrate, has been used by several researchers to improve MALDI spectra quality, to induce matrix signal suppression, and to rapidly detect and identify large proteins from Escherichia coli whole cell lysates in the mass range from 25-500 kDa.

Direct analysis of SDS-PAGE-separated proteins electroblotted onto membranes using MALDI-MS has been performed by a large number of MALDI users. In all cases, the membrane with the blotted protein spot is attached to the probe tip for direct MALDI analysis. The matrix is added to the protein spots by soaking the membrane with matrix solution. The incorporation of the proteins and peptides into the matrix crystals relies on the ability of the matrix solution to solvate the proteins adsorbed on the membrane. UV as well as IR irradiation are used to desorb/ionize the analyte molecules, with IR offering the advantage of larger penetration-depth into the membrane. Peptides produced after enzymatic or chemical digestion of proteins blotted onto a membrane have also been analyzed by MALDI, providing one of the fastest paths for protein identification after 2-D Gel separation. Poly(vinylidenefluoride) (PVDF) based membranes have been most commonly evaluated and used for these purposes. Other membranes, such as Nylon, Zitex, and polyethylene have also been found to be useful for the detection of dot blotted proteins by MALDI MS. A study demonstrates the capabilities of IR-MALDI can analyze electroblotted proteins directly from PVDF membranes, compare different membrane materials, and looks into on-membrane digestions and peptide mapping (Schleuder et al., 1999). The link between gel electrophoresis and MALDI MS has been taken one step further by introducing dried matrix-soaked gels into their mass spectrometers for direct MALDI analysis of the intact, and in-gel-digested, proteins (Philip et al., 1997). The method provides masses of both intact and cleavage products without the time and sample losses associated to electroelution or electroblotting. The key to their success is the use of ultrathin polyacrylamide gels, which dry to a thickness of 10 mm or less and which have the additional advantages of rapid preparation and electrophoresis run times. The methods are applied to isoelectric focusing (IEF), native and SDS-PAGE gels. When used in combination with IEF gels, this option makes it possible to run “virtual 2-D gels” in which proteins are resolved in the first dimension on the basis of their charge, whereas the second dimension is MALDI-MS-measured molecular weight instead of SDS-PAGE. The effects of the substrate on the MALDI signal must be carefully considered and accounted for in these experiments. Mass accuracy in desorption from gels is an important concern. Several effects conspire against high mass accuracy determinations: (a) uneven gel thicknesses, (b) difficulty mounting gels flat and (c) surface charging of the dielectric material are the three most serious problems. Delayed extraction overcomes some of the mass accuracy limitations, and accuracy to better than 0.1% is readily obtained.

Another recent development in the MALDI field is the use of molecularly tailored MALDI-probe-substrates chemically modified to selectively capture specific analytes from solution prior to mass spectrometry (Hutchens et al., 1993). The efficacy of affinity capture techniques has been demonstrated (originally termed surface enhanced affinity capture (SEAC) mass spectrometry). In the published example of SEAC, agarose beads with attached single strand DNA were used to capture lactoferrin from pre-term infanturine. After these beads were incubated in the urine sample, the beads were removed, washed, placed directly on the MALDI probe tip and analyzed with conventional MALDI. The capture agent used as a substrate did not seem to degrade the performance of the MALDI-MS. Since this original report, on-probe immunoaffinity extraction has become common place in many laboratories, and there is even commercial sources that can supply affinity-capture probes tailored to specific analysis requirements.

Rapid peptide mapping has been accomplished using an approach in which the analyte is applied directly to a mass spectrometric probe tip that actively performs the enzymatic degradation, i.e., the probe substrate carries the enzymatic reagent. Applying the analyte directly to the probe tip increases the overall sensitivity of peptide mapping analysis. High on-probe enzyme concentrations provide digestion times in the order of a few minutes, without the adverse effect of autolysis peaks. Bioreactive probe tips have been used routinely for the proteolytic mapping and partial sequence determination of picomole quantities of peptide.

E. Crystallization Methods

With minor modifications, the original and simple sample preparation procedure introduced by Hillenkamp and Karas (1988) has remained intact for over a decade, and it is commonly referred to as the dried-droplet method: An aqueous solution of the matrix compound is mixed with analyte solution. A 1 mL droplet of this solution is then dried resulting in a solid deposit of analyte-doped matrix crystal that is introduced into the mass spectrometer for analysis.

The trick is to find matrix molecules that will dry out of solution with analyte molecules in the resulting matrix crystals and that will enable the MALDI process. Poor sample preparation will yield low resolution, poor reproducibility and degraded sensitivity. MALDI optimization is primarily an empirical process that involves a significant amount of trial-and-error. Every choice during sample preparation can potentially affect the outcome of the MALDI measurement. It is not unusual to test a few different approaches before choosing the optimum protocol for sample preparation. The following are a variety of methods used for crystallization

1. Dried Droplet

The dried-droplet method is the oldest and has remained the preferred sample preparation method in the MALDI community.

Step-by-step procedure:

1. Prepare a fresh saturated solution of matrix material in the solvent system of choice: A small amount, 10-20 mg, of matrix powder is thoroughly mixed with 1 mL of solvent in a 1.5 mL Eppendorf tube, and then centrifuged to pellet the undissolved matrix.

2. Place 5-10 mL of the supernatant matrix solution in a small Eppendorf tube. (Note: Typical concentrations in saturated matrix-only solutions are in the 1-100 mM range.)

3. Add a smaller volume (1 to 2 mL) of protein solution (1-100 mM) to the matrix.

4. Mix the solution thoroughly for a few seconds in a vortex mixer.

5. Place a 0.5-2 mL droplet of the resulting mixture on the mass spectrometer sample plate.

6. Dry the droplet at room temperature. (Note: Blowing room-temperature air over the droplet speeds drying.)

7. When the liquid has completely evaporated, the sample may be loaded into the mass spectrometer. Typical analyte amounts on MALDI crystalline deposits are in the 0.1-100 picomole range.

The analyte/matrix crystals may be washed to etch away the involatile components of the original solution that tend to accumulate on the surface layer of the crystals (segregation). The procedure most often recommended is to thoroughly dry the sample (dessicator or vacuum dry) followed by a brief immersion in cold water (10 to 30 seconds in 4° C. water). The excess water is removed immediately after, by flicking the sample stage or by suction with a pipette tip.

This method is surprisingly simple and provides good results for many different types of samples. Dried droplets are very stable and can be kept in vacuum or refrigerator for days before running a MALDI experiment.

The dried-droplet method tolerates the presence of salts and buffers very well, but this tolerance has its limits. Washing the sample as described above can help; however, if signal suppression is suspected, a different approach should be tried (see crushed-crystal).

The dried-droplet method is usually a good choice for samples containing more than one protein or peptide component. The thorough mixing of the matrix and analyte prior to crystallization usually assures the best possible reproducibility of results for mixtures.

A common problem in the dried droplet method is the aggregation of higher amounts of analyte/matrix crystals in a ring around the edge of the drop. Normally these crystals are inhomogeneous and irregularly distributed, which is the reason MALDI users often end up searching for “sweet spots” on their sample surfaces. As an example, it has been observed that peptides and proteins tend to associate with the big crystals of 2,5-dihydroxybenzoicacid that form at the periphery of air dried drops containing aqueous solvent, whereas the salts are predominantly found in the smaller crystals formed in the center of the sample spot at the end of crystallization. In a clever set of experiments, Li et al. (1996) used confocal fluorescence to demonstrate that with the dried-droplet method, the analyte is not uniformly distributed among or within the matrix crystals. In fact, some crystals show no analyte at all.

Most well-written MALDI software packages allow for automated sweet-spot searching during data acquisition, a procedure by which the sample surface is scanned with the laser beam until a portion yielding strong signals is located.

Another problem that is often observed during crystallization is what is known as segregation: as the solvent evaporates and the matrix crystallizes, the salts and some of the analyte are excluded from matrix crystals. This is particularly important in cases where cationization is the ionization mechanism, such as in the case of synthetic polymers and carbohydrates. Component segregation yields an inhomogeneous mixture of analyte throughout the sample, resulting in highly variable analyte ion production as the laser is moved across the sample surface.

2. Vacuum Drying

The vacuum-drying crystallization method is a variation of the dried-droplet method in which the final analyte/matrix drop applied to the sample stage is rapidly dried in a vacuum chamber. Vacuum-drying is one of the simplest options available to reduce the size of the analyte/matrix crystals and increase crystal homogeneity by reducing the segregation effect. It is not a widespread sample preparation method, because of its mixed results and extra hardware requirements.

Step-by-step procedure:

1. Prepare the analyte/matrix sample solution following steps 1 through 4 of the dried-droplet method.

2. Apply a 0.5 to 2 mL drop of the solution to the sample stage

3. Immediately introduce the sample stage into a vacuum-sealed container and pump the sample down to <10-2 Torr with a vacuum pump. Wait until the solvent is completely evaporated.

4. Introduce the sample into the mass spectrometer.

The vacuum drying method offers the fastest way to dry a MALDI sample. Vacuum drying is 20 to 30 times faster than either air or heat drying. This is a very attractive feature for users running lots of samples, requiring high sample throughput, or dealing with low volatility solvents.

When it works, vacuum-drying provides uniform crystalline deposits with small crystals. It greatly improves spot-to-spot reproducibility and minimizes the need to search for “sweet spots.” The formation of smaller crystals offers the added advantage of thinner samples and improved mass accuracy and resolution. Reductions in the amount of laser power required for ion formation have been reported for vacuum dried samples compared to similarly prepared air or heat dried samples.

The main disadvantages of vacuum-drying are that it is not guaranteed to work better than dried droplet in all cases, and it requires accessory vacuum hardware that many analytical laboratories might not have available. Peptides and proteins analyzed with the vacuum-drying method tend to exhibit extensive alkali cation adduction. This can be substantially reduced by washing the crystals directly on the probe with cold water. With evaporation times beyond 20 seconds in a vacuum system, the vacuum drying effects becomes less pronounced.

3. Crushed Crystal

The crushed-crystal method was specifically developed to allow for the growth of analyte doped matrix crystals in the presence of high concentrations of involatile solvents (i.e., glycerol, 6M urea, DMSO, etc.) without any purification.

Step-by-step procedure:

1. A fresh saturated solution of matrix material in the solvent system of choice is prepared in the same fashion as in step 1 of the dried-droplet method. The supernatant liquid is transferred to a separate container before use to eliminate the potential presence of undissolved matrix crystals.

2. An aliquot (5 to 10 mL) of the saturated matrix solution is mixed with the protein containing solution (1 to 2 mL) to produce a final protein concentration of 0.1-10 mM. This analyte/matrix solution is equivalent to the one that would be made in the simpler dried-droplet experiment. Note: Particular attention must be paid to eliminate the presence of particulate matter in this solution. Centrifuge, and use the supernatant, if necessary.

3. A 1 mL drop of the matrix-only solution is placed on the sample stage and dried in air. The deposit formed looks identical to what is typically obtained from a dried-droplet deposit.

4. A clean glass slide (or the flat end of a glass rod) is placed on the deposit and pressed down on to the surface with an elastic rod such as a pencil eraser. The glass surface is turned laterally several times to smear the deposit into the surface.

5. The crushed matrix is then brushed with a tissue to remove any excess particles (no need to be particularly gentle)

6. A 1 mL droplet of the analyte/matrix solution is then applied to the spot bearing the smeared matrix material.

7. Within a few seconds an opaque film forms over the substrate surface covering the metal.

8. After about 1 minute the sample is immersed in room temperature water to remove involatile solvents and other contaminants. Note that it is not necessary to let the droplet dry before washing: the film does not wash off easily.

9. The film is blotted with a tissue to remove excess water and allowed to dry before loading into the mass spectrometer.

The dried-droplet method is widely used because it is simple and effective. Good signals are obtained from initial solutions that contain relatively high concentrations of contaminants (salts and buffers). Many real analytical samples contain those materials and the capacity to tolerate these impurities has an enormous practical importance. However, there are limits to the contamination tolerance of the dried-droplet method. Particularly, the presence of significant concentrations of involatile solvents reduces, or totally eliminates, the ion signals. Examples of the most common of these solvents are dimethyl sulfoxide, glycerol and urea. Removal of the involatile solvents may not be possible if they are needed to dissolve or stabilize the analyte.

The dried-droplet method forms crystals randomly throughout the droplet as the solvent evaporates. The surface of the droplet is the preferred site for initial crystal formation. The crystals form at the liquid/air interface and are then carried into the bulk of the solution by convection. The final sample deposit is littered with those crystals, and if no involatile solvent is present they become adhered to the substrate. If involatile solvents are present, the crystals might either not form or remain coated with the solvent, preventing them from attaching to the substrate. Even if crystals are formed and the deposit is introduced into the mass spectrometer, a coating of involatile solvent usually suppresses the ion signals. Attempts to wash the crystals usually results in their loss, because they are not securely bonded to the substrate.

The crushed-crystal method is operationally similar to the dried-droplet method, but the results are very different, particularly in the presence of involatile solvents. In this method rapid crystallization directly on the metal surface is seeded by the nucleation sites provided by the smeared matrix bed that is crushed on the metal plate prior to sample application. Crystal nucleation shifts from the air/liquid interface to the surface of the substrate and microcrystals formed inside the solution where the concentrations change slower. The polycrystalline film adheres to the surface so the crystallization can be halted any time by washing off the droplet before its volume decreases significantly.

The films produced are also more uniform than dried-droplet deposits, with respect to ion production and spot-to-spot reproducibility.

The disadvantage of the crushed-crystal method is the increase in sample preparation time caused by the additional steps. It does not lend itself to automation for high throughput applications. It requires strict particulate control during solution preparation to eliminate the presence of undissolved matrix crystals that can shift the nucleation from the metal surface to the bulk of the droplet.

4. Fast Evaporation

The fast-evaporation method was introduced by Vorm et al. (1994) with the main goal of improving the resolution and mass accuracy of MALDI measurements. It is a simple sample preparation procedure in which matrix and sample handling are completely decoupled.

Step-by-step procedure:

1. Prepare a matrix-only solution by dissolving the matrix material of choice in acetone containing 1-2% pure water or 0.1% aqueous TFA. The concentration of matrix can range between the point of saturation or one third of that concentration.

2. Apply a 0.5 mL drop of the matrix-only solution to the sample stage. The liquid spreads quickly and the solvent evaporates almost instantaneously.

3. Check the resulting matrix surface for homogeneity. Apart from a slight thickening at the edges, no inhomogeneity should be visible by light microscopy (>10× magnification

4. Apply a drop (1 mL) of sample solution (0.1-10 mM) on top of the matrix bed and allow to dry either by itself or in a flow of nitrogen.

5. After the drop has dried it is introduced into the mass spectrometer for analysis.

For crystal washing it is recommend to wash the crystals prior to their introduction into the TOF spectrometer. A large droplet of 5-10 mL of water or dilute aqueous organic acid (i.e., 0.1% TFA) is applied on top of the sample spot. The liquid is left on the sample for 2-10 seconds and is then shaken off or blown off with pressurized air. The procedure can be repeated once or twice. The washing liquid must be free of alkali metals and should be neutral or acidic (i.e., 0.1% TFA).

Pneumatic spraying: Pneumatic spraying of the matrix-only layer has been suggested as an alternative for fast evaporation. The process delivers stable and long lived matrix films that can be used to precoat MALDI targets.

The fast-evaporation method provides polycrystalline surfaces with roughnesses 10-100 times smaller than equivalent dried-droplet deposits. Confocal fluorescence studies demonstrated that, across an entire sample deposition area, the analyte is more uniformly distributed than with the dried-droplet method.

The improved homogeneity of the sample surface provides several advantages. (1) Faster data acquisition. All spots on the surface result in similar spectra under the same laser irradiance. No sweet-spot hunting and less averaging. The outcome of the first few laser shots is usually enough to decide the outcome of an experiment. (2) Better correlation between signal and analyte concentration (still not a quantitative technique). (3) More reproducible sample-to-sample results. (4) Improved sensitivity. The peptides have been detected down to the attomole level. The higher ion signals are explained as the result of the increased surface area of the smaller crystals combined with the preferential localization of the analyte molecules on the outer layers of the crystals from where the MALDI signal is believed to originate. (5) Improved washability. Salts and impurities are more easily washed off the sample deposits because the crystals are more securely bonded to the metal surface and to each other. (6) Improved resolution and mass measurement accuracy. Resolution improvements of at least a factor of two have been reported compared to dried-droplet results. The improved mass accuracy can often eliminate the need for internal standards. (7) Matrix surfaces can be prepared in advance. Precoated sample plates prepared by fast-evaporation of matrix solution on the sample spots are available from a few commercial sources.

Some of the disadvantages that have been associated with this method are as follows. (1) It does not provide reproducible sample-to-sample data for peptide and protein mixtures. If the protein or peptide sample contains more than one component, it is best to try the dried-droplet or overlayer method first. The thorough mixing of the analyte and matrix solutions prior to deposition increases the reproducibility of the spectra obtained. (2) Because the layer of protein-doped matrix on each crystal is usually very thin, it only produces ions for a few shots on a laser spot. The laser spot must constantly move to a fresh location to maintain the signal levels. This results in reduced duty cycle for the data acquisition loop, and reduced throughput. (3) Working with very volatile solvents such as acetone makes it difficult to make reproducible sample spots. The solvent has a small surface tension and it spreads uncontrollably along the metal surface. Some varying amount of solvent is always lost to evaporation before the matrix-only droplet is delivered. (4) The method is very effective for the analysis of peptides but is not as effective for proteins. The two-layer method should be tried first in the case of proteins.

5. Overlayer (Two-Layer, Seed Layer)

The overlayer method was developed on the basis of the crushed-crystal method and the fast-evaporation method. It involves the use of fast solvent evaporation to form the first layer of small crystals, followed by deposition of a mixture of matrix and analyte solution on top of the crystal layer (as in the sample matrix deposition step of the crushed-crystal method). The origin of this method, and its multiple names, can be traced back to the efforts of several research groups (Li et al., 1999).

Step-by-step procedure:

1. First-layer solution (matrix only): Prepare a concentrated (5-50 mg/mL) matrix-only solution in a fast evaporating solvent such as acetone, methanol, or a combination of both.

2. Second-layer solution (analyte/matrix): Prepare the second-layer solution following the three steps below: Prepare a fresh saturated solution of matrix material in the solvent system of choice: A small amount, 10-20 mg, of matrix powder is thoroughly mixed with 1 ml of solvent in a 1.5 ml Eppendorf tube, and then centrifuged to pellet the undissolved matrix. Place 5-10 mL of the supernatant matrix solution in a small Eppendorf tube. Add a smaller volume (1 to 2 mL) of protein solution (1-100 mM) to the matrix. Mix the solution thoroughly for a few seconds in a vortex mixer. This is the second-layer solution.

3. Apply a 0.5 mL drop of the first-layer solution to the sample plate and let it dry to form a microcrystalline layer.

4. Apply a 0.5-1 mL drop of the second-layer solution on top of the crystal bed and allow to air dry. Note: If the first crystal layer is completely dissolved, stop and retry using a smaller volume of second-layer solution or a different solvent system.

Washing the crystals prior to introduction into the TOF spectrometer is often recommended. A large droplet of 5-10 mL of water or dilute aqueous organic acid (0.1% TFA) is applied on top of the sample spot. The liquid is left on the sample for 2-10 seconds and is then shaken off or blown off with pressurized air. The procedure can be repeated once or twice. The washing liquid must be free of alkali metals and should be neutral or acidic (i.e., 0.1% TFA).

The difference between the fast evaporation and the overlayer method is in the second-layer solution. The addition of matrix to the second step is believed to provide improved results, particularly for proteins and mixtures of peptides and proteins.

The overlayer method has several convenient features that make it a very popular approach. (1) It naturally inherits all the advantages detailed in the fast evaporation method, and it avoids some of its limitations. (2) It provides enhanced sensitivity and excellent spot-to-spot reproducibility for proteins beyond what is possible with the fast-evaporation method. This enhancement is likely due to improved matrix isolation of the analyte molecules on the crystal surfaces in the presence of the surplus of matrix molecules. (3) With the careful optimization of the second-layer analyte/matrix solution, the overlayer method is found to be very effective for the analysis of complicated mixtures containing both peptides and proteins. The ability to manipulate the second layer conditions adds flexibility to the sample preparation.

6. Sandwich

The sandwich method is derived from the fast-evaporation method and the overlayer method. It was reported for the first time by Li (1996), and used for the analysis of single mammalian cell lysates by mass spectrometry. The report also included the description of a Microspot MALDI sample preparation to reduce the sample presentation surface to a minimum.

In the sandwich method the sample analyte is not premixed with matrix. A sample droplet is applied on top of a fast-evaporated matrix-only bed as in the fast-evaporation method, followed by the deposition of a second layer of matrix in a traditional (non-volatile) solvent. The sample is basically sandwiched between the two matrix layers.

7. Spin Coating

The preparation of near homogeneous samples of large biomolecules, based on the method of spin-coating sample substrates was reported for the first time by Perera (1995). In the original report, samples were deposited on 1” diameter stainless steel and quartz plates, and large volumes (3-10 mL) of the premixed sample solution were used. The spin coater was home-built and it operated at about 300 rpm, producing evenly spread crystal deposits in air. The samples were very homogeneous and generated highly reproducible and much enhanced molecular-ion yields from all regions of the sample target.

Spin coating the analyte/matrix samples works well and it usually delivers more homogeneous deposits on single-spot sample stages. However, it is not a viable option for MALDI plates with multiple sample wells of the kind found in all modern commercial instruments.

8. Slow Coating

It is possible to grow large, protein doped matrix crystals under near equilibrium conditions, rather than in a rapidly drying droplet (Beavis and Xiang, 1993). Supersaturated matrix solutions containing protein will form crystals that can be used directly in an ion source. Supersaturation can be achieved by heating, cooling or slow evaporation. The protein-doped crystals can be cleaved to expose well defined faces to the laser beam.

In general the slow crystallization approach favors the detection of high mass components over low mass peptides, regardless of pH and solution

Producing large protein-doped crystals has several disadvantages compared to the fast drying (non-equilibrium) crystallization techniques described elsewhere: (1) It is slower. Crystals take hours to grow, definitely not practical for large-scale, high-throughput applications. (2) Peak broadening is often observed. (3) High mass accuracy is out of the question due to the irregular geometry of the sample bed. (4) Growing crystals requires more analyte (10-100×) than traditional methods.

However, even with those difficulties some advantages are also realized: (1) Crystals can be grown from solutions with involatile solvents at concentrations that suppress ion signals from dried droplet experiments. (2) High concentrations of non-protenaceous solutes do not affect crystal doping. Detergents are an exception. (3) Mixtures of polypeptides can be incorporated into crystals and analyzed. (4) Crystals can be easily manipulated. Common operations are washing, cleaving, etching and mounting. (5) The crystals are very rugged. (6) The crystals provide more defined starting conditions for fundamental MALDI ionization mechanism studies.

9. Electrospray

Electrospray as a sample deposition for MALDI-MS was suggested by Owens and Axelsson (1997; 1999). In this technique, a small amount of matrix-analyte mixture is electrosprayed from a HV-biased (3-5 KV) stainless steel or glass capillary onto a grounded metal sample plate, mounted 0.5-3 cm away from the tip of the capillary.

Electrospray sample deposition creates a homogenous layer of equally sized microcrystals and the guest molecules are evenly distributed in the sample. The method has been proposed to achieve fast-evaporation and to effectively minimize sample segregation effects. The presence of cation adducts in the MALDI spectra from electrodeposited samples demonstrates that solution components are less segregated than in equivalent dried-droplet deposits.

Electrospray matrix deposition was used (Caprioli et al., 1997) to coat tissue samples during the MALDI based molecular imaging of peptides and proteins in biological samples. Matrix-only solution was electrosprayed on TLC plates for the direct MALDI analysis of the impurity spots of tetracycline samples (Clench et al., 1999).

Electrospray deposited samples have been shown to give several advantages over traditional droplet methods: (1) The reproducibility of MALDI results from spot-to-spot within one sample deposit, and from sample-to-sample for multiple depositions, is much improved. Typical sample-to-sample variations are in the 10 to 20% range. (2) The correlation between analyte concentration and matrix signal is also improved. Quantitation with internal standards has been reported by Owens. (3) The sample deposits are much more resistant to laser irradiation. More shots can be collected from any single laser spot location. (4) The method offers a possible path for interfacing MALDI sample preparation to Capillary electrophoresis and liquid chromatography.

Disadvantages: (1) Slower. It takes 1 to 5 minutes to create a useful deposit. It also takes time to switch to a new analyte since the capillary must be thoroughly cleared of any leftover sample from the last measurement before spraying can start. (2) Salt adducts are a problem and desalting of the matrix and the sample is usually needed to eliminate cationization signals. (3) Extra equipment is required, along with training. (4) It involves the use of dangerous high voltages.

Aerospray (pneumatic spraying) has been suggested as an alternative sample spraying method. Recent results have demonstrated high degree of reproducibility for this sample preparation technique (Wilkins et al., 1998). Homogeneous thin films can be easily made, with good spot-to-spot and sample-to-sample reproducibility.

The potential exists to combine both techniques, using aerospray for the nebulization and an electric field to control solvent evaporation and droplet size.

10. Matrix Pre-Coated Targets

The use of matrix-precoated targets for the MALDI analysis of peptides and proteins has been investigated by several research groups. It is easy to realize the advantages of a sample preparation method reduced to the straightforward addition of a single drop of undiluted sample to a precoated target spot. Such a method would not only be faster and more sensitive than the ones described before, but it would also offer the opportunity to directly interface the MALDI sample preparation to the output of LC and CE columns.

Early efforts described the use of a pneumatic sprayer to fast-evaporate a thin matrix-only layer on a MALDI target (Kochling and Biemann, 1995). The microcrystalline films were very stable and long-lived and provided adequate MALDI spectra for peptides and small proteins.

Most other efforts have focused on the development of thin-layer matrix-precoated membranes. Particular attention has been dedicated to the choice of membrane material. Some of the options that have been tested (with varying results) include: nylon, PVDF, nitrocellulose, anion- and cation-modified cellulose and regenerated cellulose. Particularly encouraging results, in terms of sensitivity and quality of spectra, were obtained by Zhang and Caprioli (1996) for regenerated cellulose dialysis membrane. Their membrane precoating procedure provided results comparable to dried-droplet method for peptides and small proteins under 25 KDa. Heavier proteins (>25 KDa) gave poorer results, presumably due to the limited amount of matrix available in the precoated membranes and/or the inability to form protein doped microcrystals.

It has been observed that using nitrocellulose in a sample preparation for MALDI-TOF MS of peptides can increase ion yields (Preston et al., 1993). Mass spectrometry and optical microscopy results suggest that the nitrocellulose addition modifies the crystallization of the matrix-analyte solution to allow more even coverage over the sample surface.

Hutchens (1993) developed a sample preparation technique they called Surface-Enhanced Neat Desorption (SEND) in which energy-absorbing-molecules were bound to substrates to provide chemically modified surfaces capable of desorbing “neat” analyte ions. The results were very encouraging, but the technique was never mainstreamed into the general MALDI methodology.

IV. Protein Treatments

There are two basic methods for digesting proteins: enzymatic and chemical methods. Enzymatic digestions are more common. An ideal digestion cuts only at a specific amino acid, but cuts at all occurrences of that amino acid. The number of digestion sites should not produce too many peptides because separation of peptides becomes too difficult. On the other can, too few digestions produces peptides too large for certain kinds of analysis.

The most common digestions are with trypsin and lysine specific proteinases, because these enzymes are reliable, specific and produce a suitable number of peptides. The next most common digestion is at aspartate or glutamate using endoproteinase Glu-C or endoproteinase Asp-N. Chymotrypsin is sometimes used, although it does not have a well defined specificity. Proteinases of broad specificity may generate many peptides, and the peptides may be very short. Of the chemical cleavages, cyanogen bromide is the most common. All the chemical digestions are less efficient than a good enzymatic digest. However they do produce only a few peptides, which can ease any purification problem.

V. Design of Standard Peptides

Selection of reference peptides and design of standard peptides is an important aspect of accurate quantitative MALDI-TOF MS. For a given protein, a signature peptide or peptides must be selected that is (are) specific and unique to that protein in the context in which it will be measured. A highly conserved protein such as human cardiac α myosin heavy chain would have diagnostic peptides shared with other species, but if only human samples were to be analyzed, then the diagnostic peptide would only have to discriminate human cardiac α myosin heavy chain from other human cardiac myosin isoforms. The selection of the diagnostic peptide thus sets the parameters for the design of the standard peptide.

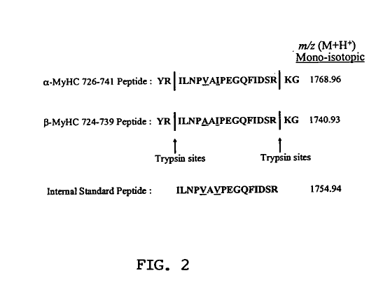

The standard peptide is highly homologous to the diagnostic peptide; thus, the sequence of the diagnostic peptide is the starting point for the design of the standard peptide. The sequence must now be altered to change the mass of the standard peptide so it can be discriminated from the reference peptide by MALDI-TOF MS while maintaining the chemistry of the original reference peptide. This is achieved most readily by a single conservative amino acid substitution (in this case a V for a I, FIG. 2) allowing for the standard peptide to be easily prepared with standard solid phase peptide synthesizers. Unusual amino acids or stable isotope amino acids can also be used. The substitution should not change the charge or hydrophobicity of the peptide as this would alter the recovery of the peptide or the ability of the peptide to co-crystallize with matrix or the ability to ionize, and therefore change the production of its MALDI-TOF signal. The standard peptide must also have a MALDI-TOF MS mass signal that does not overlap with any other peptide present in the sample. Obviously, this becomes more difficult as the complexity of the sample increases.

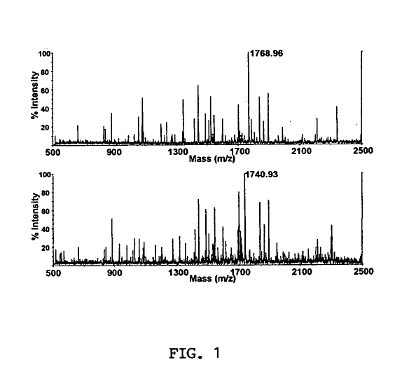

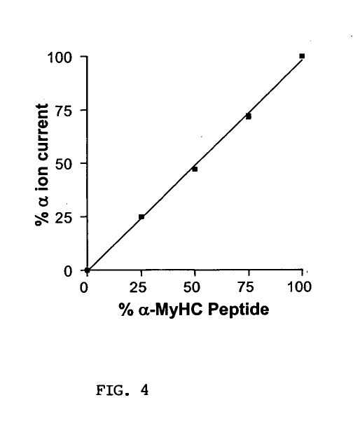

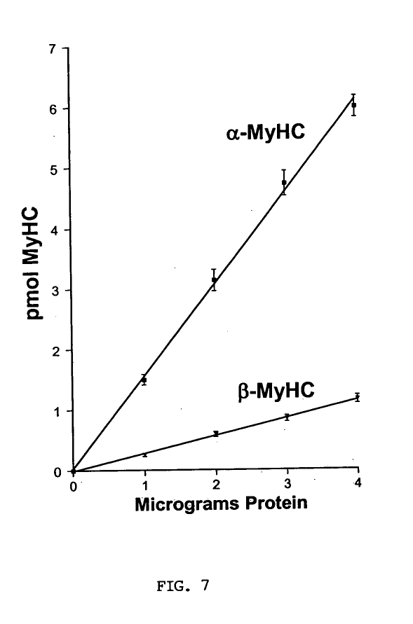

In the examples described herein, one dimensional gel electrophoresis was sufficient to produce a cardiac myosin heavy chain sample with a MALDI-TOF spectra that had an open region in which the standard peptide signal could appear without interference from other peptides. For other proteins it may be necessary to perform two dimensional electrophoresis or immuno-precipitation to produce a sample with a MALDI-TOF spectra that has an open region in which the standard peptide signal can appear without interference from other peptides. This open region must be near the reference peptide since the standard peptide will have a mass close to that of the reference peptide. This can impact the choice of the reference peptide. If there are several potential reference peptides, then the sample spectra can be inspected to find the reference peptides that have the highest signal and that have nearby open regions for the standard peptide signal. In this case, the selected cardiac myosin heavy chain reference peptides gave the highest signals in the spectra (FIG. 1) and the region between them was open (FIG. 4) for the standard peptide (FIG. 7). For any given protein and sample, the MALDI-TOF spectra will need to be analyzed to select the optimal reference peptides, which then permit design of the optimal standard peptides by the procedures described above.

VI. Myosin Heavy Chain (MyHC) Isoforms

Two isoforms of cardiac MyHC are expressed in the mammalian heart, α-MyHC and β-MyHC. The α-MyHC is a fast MyHC with a rapid rate of ATP hydrolysis while β-MyHC is a slow MyHC. The rate of ATPase activity correlates directly with the speed of myocardial contraction (Schwartz et al., 1981; Swynghedauw et al., 1986; Nadal-Ginard et al., 1989) and the velocity of actin filament sliding (Harris et al., 1994; Van Buren et al., 1995). Small adult mammals such as rodents express predominantly α-MyHC while large adult mammals such as humans express predominantly β-MyHC (Rouslin et al., 1996; Clark et al., 1982; Gorza et al., 1984). The ratio of the isoforms in rodents can be altered by aging (Dechesne et al., 1985; Fitzsimons et al., 1999), exercise (Pagani et al., 1983), or changes in thyroid hormone (Dechesne et al., 1985; Hoh et al., 1978; Martin et al., 1982). Pressure overload, volume overload, or cardiac infarct will induce hypertrophy in the rodent heart that is accompanied by down regulation of the α-MyHC gene and up regulation of the β-MyHC (Nadal-Ginard et al., 1989; Lompre et al., 1979; Schwartz et al., 1992; Schwartz et al., 1993; Parker et al., 1998). The cardiac isoforms of rodents can be easily separated by electrophoresis allowing these changes to be followed at the protein level. In contrast, the human isoforms are very difficult to resolve as discussed below. A recently published study of particular interest found that rat myocytes expressing 12% α-MyHC developed 52% more power output than those expressing 0% α-MyHC (Herron et al., 2002). Theoretical models also predict that a small amount of α-MyHC could significantly accelerate the rate of force production (Razumova et al., 2001). These studies are very relevant to human hearts, which express small amounts of α-MyHC and suggest that small amounts of α-MyHC could be critical for normal human heart function.

In humans, there also is a down regulation of α-MyHC mRNA in heart failure due to IDC or CAD (Lowes et al., 1997; Nakao et al., 1997). The percentage of α-MyHC mRNA is ˜30% in normal heart and 15% in the failing heart. Of particular interest is a recently published study on patients treated for heart failure with β-adrenergic receptor blockers. Patients who responded favorably to treatment as measured by increased ejection fraction demonstrated an increase in α-MyHC mRNA and a decrease in β-MyHC mRNA (Lowes et al., 2002) and this suggests that α-MyHC is very important for human heart function. Because of the poor correlation between mRNA and protein concentrations it is important to measure α-MyHC protein.

A reduction in immunofluorescent staining for α-MyHC has been observed in hypertrophic (Gorza et al., 1984) IDC, and CAD (Bouvagnet et al., 1989) human hearts but this method is difficult to quantify. The human cardiac MyHC isoforms are very similar and cannot be separated by normal electrophoretic procedures used to resolve the rodent isoforms. Small amounts of human MyHC can be separated by a specialized electrophoretic technique (Reiser et al., 1998). One group using this technique found that the normal human left ventricle contained 7.2% α-MyHC protein and that IDC and CAD left ventricles contained no detectable α-MyHC (Miyata et al., 2000). Another group found that the α-MyHC content was 2.5% for normal human left ventricles, 0.3% for IDC left ventricles, and 1.3% for CAD left ventricles (Reiser et al., 2001). These inconsistencies likely arise because with this method good separation is difficult to achieve and the small sample loads require silver staining. Silver staining has a very limited dynamic range so the staining intensity is not linear with protein concentration. This points out the need for an accurate cardiac MyHC protein isoform assay for use in diagnosis and the monitoring of treatment.

VII. Actin Isoforms

Cardiac α-actin (C actin) and skeletal α-actin (S actin) are extremely homologous proteins differing in only 4 amino acids yet these differences are completely conserved from birds to humans and the isoforms are expressed in a tightly regulated developmental and tissue specific pattern (Kumar et al., 1997; Rubenstein et al., 1990). This suggests that the minor differences between these isoforms are physiologically important and that the forms are not interchangeable.

In early rodent heart development C and S actin are co-expressed, while in the normal adult heart S actin is down regulated and C actin is expressed almost exclusively (Schwartz et al., 1992). Disruption of the C actin gene results in most of the mice not surviving until birth and the rest succumbing within two weeks even though there is some up-regulation of S actin (Kumar et al., 1997; Jones et al., 1996). Ectopic expression of enteric smooth muscle g-actin (E actin) can allow these mice to survive but their hearts are hypodynamic and hypertrophied suggesting that only C actin can support normal cardiac development. In chick embryo development the expression of C actin coincides with the attainment of mature uniform thin filament lengths. Thus, C actin may be required for correct cardiac sarcomere assembly (Gregorio and Antin, 2000; Littlefield and Fowler, 1998). In the adult rodent heart upregulation of S actin is a classic hallmark of hypertrophy induced either by pressure overload (Nadal-Ginard et al., 1989; Schwartz et al., 1992; Schwartz et al., 1993; Mercadier et al., 1993) (and many others) or myocardial infarction (Parker et al., 1998; Orenstein et al., 1995; Tsoporis et al., 1997). This has been interpreted as a reactivation of a fetal gene program. Interestingly, BALB/c mice naturally express a large amount of S actin in their hearts (Alonso et al., 1990) and this expression has been correlated with increased contractility (Hewett et al., 1994). Thus increased S actin expression during hypertrophy could be a compensatory mechanism.

In humans the situation is unclear. In early development S actin is not detectable (Boheler et al., 1995) suggesting that C actin is sufficient for cardiac development. S actin mRNA begins to be expressed at 13 weeks gestation and increases from about 20% of total actin mRNA at birth to about 60% in the adult (Boheler et al., 1991). Using RNA dot blots one group found no difference in the amount of S actin mRNA from patients with dilated cardiomyopathy or coronary artery disease compared to normal hearts. Another group using Northern blots found that hypertrophic cardiomyopathy patients had a four fold increase in the expression of S actin mRNA compared to normal hearts (Lim et al., 2001). A major problem with all the studies cited is that measurements were only made on mRNA and not protein. This is because the untranslated regions of the mRNAs are divergent enough to easily distinguish the isoform mRNAs while the proteins are so homologous as to be almost indistinguishable. However, it has been found in a study of dilated cardiomyopathy patients that C and S actin mRNA concentrations vary widely and do not correlate with protein concentrations (dos Remedios et al., 1996). It has been well established that in eukaryotes there is often very poor correlation between mRNA and protein (Anderson et al., 1997; Gygi et al., 1999).

The only published method to differentiate actin proteins is very cumbersome, laborious, and requires a large amount of material (Vandekerckhove et al., 1986). According to this procedure the adult human heart contains about 20% S actin, but only a single normal heart and single hypertrophic heart were examined. A major problem was the lack of pure actin isoforms to use as standards. Because of the difficulty of this method it has never been used subsequently. A better assay to measure C and S actin protein is required to address the role of these actins in human heart disease.

Studying both the MyHC and actin isoforms is important because they directly interact to form the core of the sarcomere and to generate force. MyHC can catalyze the polymerization of actin (Rayment et al., 1993), and sarcomeric actin filament length is regulated by interactions with MyHC (Littlefield and Fowler, 1998). Certain actin isoforms preferentially activate certain MyHC isoforms (Hewett et al., 1994). C and S actins differ in the arrangement of the acidic residues at the amino terminus and this region, which has been shown to bind to MyHC (Rayment et al., 1993), is required for motility (Sutoh et al., 1991). Another difference is at residue 300, which is Leu in C actin and Met in S actin. This is part of another MyHC binding site and a nearby naturally occurring C actin human mutation, A295S, causes a familial hypertrophic cardiomyopathy thought to be the result of impaired force generation (Mogensen et al., 1999). The site on MyHC that binds the actin amino terminus (Rayment et al., 1993) differs by 12 out of 20 amino acids between α-MyHC and β-MyHC. Also α-MyHC and β-MyHC can form heterodimers and interact dynamically with each other in sliding filament assays (Harris et al., 1994; Sata et al., 1993).

### VIII. Examples

The following examples are included to further illustrate various aspects of the invention. It should be appreciated by those of skill in the art that the techniques disclosed in the examples which follow represent techniques and/or compositions discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Materials and Methods

Preparation of MyHC from tissue. A panel of seven archived patient samples of normal human right atrium from organ donor candidates was provided by the Donor Alliance Organ Recovery System. Total myosin was partially purified from the tissue by the method of Caforio et al. (1992), as modified in Miyata et al. (2000). Tissue (50-100 mg) was ground under liquid nitrogen and homogenized in low-salt buffer (1 ml, 20 mM KCl, 2 mM KH2PO4, 1 mM EGTA, 1 mM 4-(2-aminoethyl)benzenesulfonyl fluoride hydrochloride (AEBSF), pH 6.8). The homogenates were centrifuged (2700×g, 10 min, 4° C.) and the supernatants discarded. The pellets were re-homogenized in 1 ml of low-salt buffer and centrifuged as before. Pellets were suspended in high-salt buffer (0.25-0.50 ml, 40 mM Na4P207, 1 mM MgCl2, 1 mM EGTA, pH 9.5), incubated on ice (30 min), and centrifuged (20,000×g, 20 min, 4° C.). The supernatant containing the partially purified myosin was collected and assayed for protein concentration by the method of Bradford (Bio-Rad Protein Assay, Bio-Rad, CA). Triplicate aliquots containing 0.15 mg total protein were electrophoresed on large format gels by the method of Reiser et al., (1998; 2001) and silver stained. This method can resolve very small amounts of human α- and β-MyHC.

The same preparations were used for MS analysis. Duplicate aliquots of 3 mg total protein were electrophoresed using the NuPage system (Invitrogen) on 4-12% Bis-Tris mini-gels with MOPS running buffer. For determinations of assay linearity, duplicate aliquots of 0, 1, 2, 3, and 4 mg of protein were electrophoresed. Gels were stained with colloidal Coomassie (Invitrogen) and destained with water. This method resolves MyHC from other proteins but does not separate the isoforms. Both α- and β-MyHC are present in the MyHC band. Images of silver stained and colloidal Coomassie stained gels were captured on a PowerLook II scanner (UMAX) and analyzed by densitometry.

Preparation of MyHC peptides for MALDI-TOF MS. The MyHC band was excised from the Coomassie stained gels and placed in 0.3 ml glass vials with Teflon caps (Alltech) in which all further processing was done. The glass vials had been washed with soap, rinsed with water, soaked in 10% TFA, extensively rinsed with 18 MW water, and dried prior to use. The gel pieces were washed twice with 50% acetonitrile (CH3CN)/25 mM ammonium bicarbonate, once with 100% CH3CN and dried in a vacuum centrifuge (Centrivap Concentrator, Labconco). The dried gel pieces were rehydrated with 20 ml of 50 mM ammonium bicarbonate, pH 8.0, containing 400 ng of sequencing grade trypsin (Promega) for 20 min on ice. The wet gel pieces were incubated overnight at 37° C. and then placed on ice. A second aliquot of 400 ng of sequencing grade trypsin in 20 ml of 50 mM ammonium bicarbonate, pH 8.0, was added and incubated for 20 min on ice. The gel pieces were again incubated (overnight, 37° C.). Tryptic peptides were extracted by adding 200 ml of 50% CH3CN/0.1% trifluoroacetic acid (TFA) and shaking for 4 hours. In experiments for absolute quantification a carefully measured aliquot containing 2 pmol of the internal standard peptide was added at this step. The gel pieces were removed from the glass vials with a syringe needle taking care not to remove any of the extract. The extract was taken to dryness in a vacuum centrifuge and resolubilized by adding 20 ml of 0.1% TFA and incubating overnight. A ZipTip, with a 0.6 ml bed volume of C18 (Millipore), was wetted twice with 20 ml of 50% CH3CN/0.1% TFA and equilibrated twice with 20 ml of 0.1% TFA. The resolubilized peptide extract was bound to the ZipTip by pipetting ten times through the bed. Three 20 ml aliquots of 0.1% TFA were pipetted through the bed to elute contaminants. The last wash was completely expelled from the ZipTip. A second 0.3 ml glass vial was cleaned as described and 2 ml of 80% CH3CN/0.1% TFA was added. The peptides were eluted into this vial by pipetting this solution through the bed five times. The entire 2 ml was spotted onto a steel MALDI-TOF MS plate along with 1 ml of matrix solution. The matrix solution consisted of recrystallized α-cyano-4-hydroxy cinnamic acid (CHCA) dissolved in 80% CH3CN/0.1% TFA at a concentration of 10 mg/ml. The peptide and matrix mixture was allowed to air dry and subjected to MALDI-TOF MS.

Preparation of peptide standards for MALDI-TOF MS. Peptide standards consisted of the α-MyHC peptide, the β-MyHC peptide, and the internal standard peptide (FIG. 2). These peptides were synthesized at the Molecular Resources Center of the National Jewish Hospital of Denver. The peptides were purified by 2 rounds of reverse phase HPLC using very shallow CH3CN gradients for maximal purity. Purity was verified by MALDI-TOF MS and ESI-TOF MS. Stock solutions of each peptide at approximately 0.4 mM were prepared in 5% CH3CN to prevent adsorption to glass vials and plastic pipette tips. Stock solutions and dilutions were always prepared in 5% CH₃CN in glass vials that had been cleaned as previously described. The exact concentrations of the stock solutions were determined by amino acid analysis in triplicate of Asx, Glx, Pro, Gly, Ala, Val, Ile, Leu, and Phe using a Beckman 6300 High Performance Amino Acid Analyzer.

Mixtures of the α-MyHC peptide and the β-MyHC peptide were prepared to generate the standard curve for relative isoform quantification. The peptides were first diluted with 5% CH3CN from 0.4 mM to 15 mM. These intermediate dilutions were mixed in various proportions to give 0-100% α-MyHC peptide. These mixtures were supplemented with CH3CN to a final concentration of 80% and TFA to a final concentration of 0.1% and then 2 ml was spotted onto the MALDI plate. The spot for 0% α-MyHC peptide contained 0 pmol α-MyHC peptide and 4 pmol β-MyHC peptide. Similarly prepared were spots for 25% α-MyHC peptide (1 pmol α-MyHC peptide and 3 pmol β-MyHC peptide), 50% α-MyHC peptide (2 pmol αMyHC peptide and 2 pmol β-MyHC peptide), 75% α-MyHC peptide (3 pmol α-MyHC peptide and 1 pmol β-MyHC) and 100% α-MyHC peptide (4 pmol α-MyHC peptide, and 0 pmol β-MyHC peptide). One ml of matrix solution was added to each sample on the target and allowed to air dry.

Mixtures of the α-MyHC peptide and the internal standard peptide were made to generate the standard curve for the absolute quantification of α-MyHC. Intermediate dilutions were prepared, mixed, supplemented with CH3CN, and spotted as previously described. The spots contained 2 pmol of the internal standard and 0-6 pmol α-MyHC peptide. In the same manner, mixtures of the β-MyHC peptide and the internal standard peptide were prepared to generate the standard curve for the absolute quantification of β-MyHC. The spots contained 2 pmol internal standard and 0-4 pmol β-MyHC peptide. One ml of matrix solution added to each spot and allowed to air dry.

Acquisition of MALDI-TOF MS spectra and data analysis. All spectra were acquired on a Voyager-DE PRO mass spectrometer (Applied Biosystems) operating in reflector mode. This provides the highest mass resolution so that the signal from the peptides of interest would not be contaminated with signals from other components of the complex protein digests. A mixture of angiotensin I, glul-fibrino-peptide B, and ACTH (18-39) in matrix was spotted adjacent to all samples and was used for external mass calibration. Data were accumulated over the limited mass window of m/z 1000-2500. All samples, including standard mixtures, were prepared in duplicate and spotted, and spectra were acquired from five different regions of each spot to give 10 spectra for each sample. Each spectrum was the result of averaging 100 separate laser shots. The laser power was carefully monitored to be high enough to have a good signal/noise ratio but low enough to remain under 50% saturation of the detector. Excessive laser power resulted in a nonlinear response to higher concentrations of peptides. All spectra from peptide standards and protein digests were processed in the same manner. A macro was written in DataExplorer (Applied Biosystems) which truncated the spectra to an m/z range of 1735 to 1780, applied a noise filter with a correlation factor of 0.7, and baseline corrected the spectra. The mass peak list data file was then exported and processed by an algorithm written in the Java computer language.

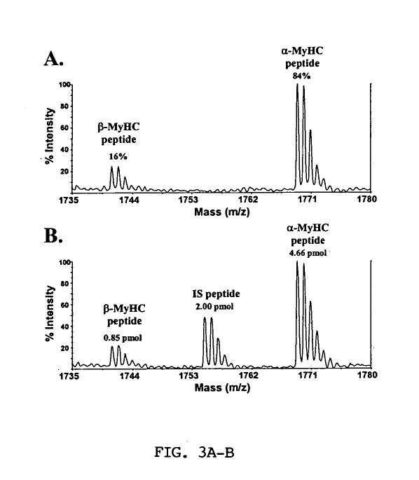

The algorithm identified the monoisotopic peak (M) and the primary isotope peak (M+1) of each peptide. This was done by searching the list of centroid masses for the values closest to the calculated masses of these peaks. An error limit of 0.5 Daltons was permitted because spectra were externally calibrated. Correct peak identification was verified by inspection of the spectra. The algorithm extracted the peak height intensity data for the monoisotopic peak, M, and the primary isotope peak, M+1, of each peptide. These were summed to give the ion current for the peptide of interest. The peak height intensities were found to be more reproducible than peak areas as has been previously shown (Nelson et al., 1994). The peak area measurements were compromised by the unstable baseline characteristic of the MALDI process. Across the mass range of these peptides M and M+1 are of a similar intensity (FIG. 3) so both were used for ion current determinations. Other members of the isotope series, M+2, M+3, etc. were of much lower relative abundance so they were not incorporated in the calculations. The algorithm determined ion currents in this way for the α-MyHC peptide, the β-MyHC peptide, and the IS peptide.

For the relative isoform measurements a standard curve was constructed as described above with mixtures of the α-MyHC peptide and β-MyHC peptide. The mixtures contained 4 pmol total peptide and varied from 0-100% α-MyHC peptide. There were ten spectra for each point on the standard curve. For each spectrum the ion current of the α-MyHC peptide was divided by the sum of the ion currents of the α-MyHC peptide and the β-MyHC peptide, and this was converted to a percentage, the % α ion current. These ten values were averaged and the standard deviation calculated. The algorithm used linear regression analysis of all ten values at each point to derive a line for the standard curve. Higher order analysis did not significantly improve the curve fit.

In the same manner as for the standards, there were ten sets of spectra acquired for each atrial panel sample. Once again the ion currents associated with the α-MyHC and β-MyHC peptides were processed to give the % a ion current. The algorithm used the standard curve to convert the % a ion current to the % α-MyHC peptide. The ten values for the % α-MyHC peptide were averaged and the standard deviation calculated.

For the absolute amount measurements the standard curves were constructed using mixtures of the IS peptide and either the α-MyHC peptide or the β-MyHC peptide. For the α-MyHC peptide standard curve there were 0-6 pmol α-MyHC peptide and 2 pmol of the IS peptide. There were ten spectra for each point on the standard curve. The ion current derived from the α-MyHC peptide was divided by the ion current of the IS peptide to give the ion current ratio (a/IS) for each spectrum. The ten values were averaged and the standard deviation calculated. The algorithm used linear regression analysis of all ten values at each point to derive a line for the standard curve relating the ion current ratio (a/IS) to the pmol α-MyHC peptide.

A known amount, 2 pmol, of internal standard peptide was added to each atrial panel sample and ten spectra were accumulated. For each spectrum the ion current of the α-MyHC peptide was divided by the ion current of the IS peptide to give the ion current ratio (a/IS). The algorithm employed the standard curve to convert the ion current ratio (a/IS) to pmol of α-MyHC peptide. The ten separate values were averaged and the standard deviation calculated.

The β-MyHC peptide standard curve was constructed using 0-4 pmol of the β-MyHC peptide and 2 pmol of the IS peptide. Spectra were accumulated and processed in the same way as for the o-MyHC peptide standard curve except that the ion current ratio (b/IS) was employed. The 10 spectra from each atrial panel sample containing 2 pmol IS peptide were also analyzed to generate the b/IS ion current ratio. These ratios were converted to pmol of β-MyHC peptide by reference to the standard curve. These 10 values were averaged and the standard deviation calculated. Both the pmol of α-MyHC peptide and the pmol of β-MyHC peptide were determined independently in the atrial panel samples.

### Example 2

### Results

A. Measuring Protein Isoform Ratios by MALDI-TOF MS

Selection of isoform specific quantification peptides. The presence of two isoforms in the MyHC gel band from Coomassie stained NuPage gels was confirmed by peptide mass fingerprinting. While approximately three quarters of the peptides matched both α- and β-myosin heavy chain, the remaining peptides were specific to one or the other isoform. This confirmed that the band contained a mixture of both isoforms. The sequences of α- and β-MyHC were examined to find a pair of tryptic peptides, one from each isoform, which would be suitable for MALDI-TOF MS quantification. Suitable peptides, in theory, should be similar in sequence, be discriminated by mass, and should generate a strong MALDI-TOF ion current. Ideally, the peptides should have identical trypsin sites so that they are both produced without discrimination by tryptic digestion. Further, it is also important that their chemistry should be very similar so that their recovery, crystallization with matrix, and ionization by MALDI would be equivalent. These requirements would readily be achieved by a single conservative amino acid substitution (e.g., leucine for isoleucine was excluded since their masses are identical). A search of the sequences revealed about ten pairs of tryptic peptides fitting these criteria. Inspection of the spectra revealed that one of these pairs gave a very strong ion current (FIG. 1). The top panel shows a spectrum of a sample that is predominantly α-MyHC; the bottom sample is predominantly β-MyHC. The α-MyHC peptide, monoisotopic mass of 1768.96, and the β-MyHC peptide, monoisotopic mass of 1740.93, have the strongest signals in these spectra and their sequences and flanking tryptic sites are shown in FIG. 2.

Preparation of MyHC peptides for MALDI-TOF MS. For the purposes of quantification it was important to completely digest all the myosin to peptides and to extract all the peptides since the method relied on there being the same number of moles of peptide extracted as there were moles of myosin isoform in the original sample. When two rounds of trypsin digestion were compared to a single round there was no additional production of peptides (data not shown). However, it was thought that two rounds would ensure complete production of the desired tryptic peptides. This, and the relatively large ratio of trypsin to substrate, helped ensure complete peptide production. It was found that glass vials gave more reproducible preparations of tryptic peptides. The 50% CH₃CN/0.1% TFA peptide extraction solution removed components from some plastic vials that interfered with matrix crystallization. Using 0.1% TFA for peptide extraction did not extract plastic components but only extracted a portion of the peptides. The large volume of 50% CH₃CN/0.1% TFA used to extract gel pieces in glass vials completely extracted the peptides. Re-extracting gel pieces with a second aliquot of 50% CH₃CN/0.1% TFA did not yield any detectable peptides indicating that the first extraction was complete (data not shown). Clean-up on a microcolumn prepared with C18 (ZipTip, Millipore) was important to remove contaminants from the gel pieces that interfered with matrix crystallization. A sample of MyHC from a normal human atrium was prepared and a narrow MS window containing the α- and β-MyHC quantification peptides is shown in FIG. 3A. The observed ion current ratio was consistent with the proportion of α- and β-MyHC determined by silver stained Reiser gels.

Preparation of peptide standards and generation of standard curves. The quantification peptides for α- and β-MyHC were prepared synthetically at high purity to use as MS standards. Dilutions of standard peptide solutions were prepared in 5% CH₃CN in glass vials. Glass vials were used because the peptides, especially at high dilution, bind to plastic vials reducing the concentration of peptide in solution. The peptide standards were mixed in various ratios which, for clarity, are referred to by the % a peptide (i.e., the % a peptide=100×[a peptide]/[α peptide+β peptide]). These mixtures were subjected to MALDI-TOF MS and the data were analyzed as described in the experimental section. The % a ion current was defined as 100×(α ion current)/(α ion current+β ion current). The % a ion current was graphed against the % a peptide content to generate the standard curve shown in FIG. 4. Each point is the average of ten measurements and the standard deviations are indicated. (SD is ca. 1% and is therefore difficult to visualize on the plots as shown.) This plot indicates that the ion current ratio was directly proportional to the peptide ratio and that MALDI-TOF MS can be used in this manner for the quantification of peptide ratios.

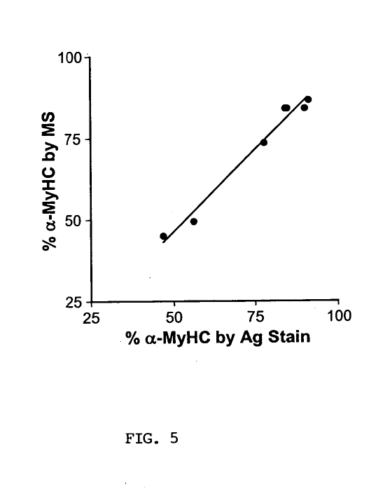

Comparison of Ratio Quantification by MALDI-TOF MS and by Silver Stained Reiser Gels. Total myosin was partially purified from a panel of normal human right atria by the method of Caforio et al. (1992). Triplicate aliquots were analyzed using the gel system of Reiser et al. (1998; 2001) in which very small amounts of α- and β-MyHC can be resolved from each other and silver stained. Densitometry of the α- and β-MyHC bands was performed to determine the proportion of the α- and β-MyHC isoforms. (Miyata et al., 2000; Reiser et al., 2001) These same samples were then resolved on NuPage gels and the MyHC band processed as described in the experimental section. A narrow window of a representative spectrum is shown in FIG. 3A. The % α-MyHC as determined by MALDI-TOF MS for the panel was graphed against the % α-MyHC as determined by silver stained gels (FIG. 5). The two methods returned equivalent values over a range of ratios as indicated by the r2 (0.979) and slope (1.01). The silver stained gel method of Reiser is currently the best available method to measure human α- and β-MyHC isoform ratios. The correlation of the MALDI-TOF MS results with the silver stained gel method shows that protein isoform ratios can be measured by measuring tryptic peptide ratios.

B. Measuring Protein Amounts by MALDI-TOF MS

Design of an internal standard peptide. The relative amounts of the α- and β-MyHC isoforms can be determined from the relative amounts of the α- and β-MyHC isoform specific peptides, but in order to quantify the absolute amounts of the α- and β-MyHC peptides the incorporation of an internal standard is required. A known quantity of the internal standard peptide can be added to tryptic digest peptides and carried through the processing steps. Using appropriate standard curves the ratio of the isoform specific peptides to the internal standard peptide can be determined. From this ratio, and the amount of the internal standard added, the amount of the isoform specific peptide can be determined. Design of the internal standard peptide should take into account the same issues as described previously for the selection of the isoform specific peptides. The internal standard peptide should be very similar to the isoform specific peptides yet be discriminated by mass and should generate a strong MALDI-TOF ion current. The chemistry should be very similar so that its recovery, crystallization with matrix, and ionization by MALDI would be equivalent to the isoform specific peptides. This is most readily achieved by conservative amino acid substitutions. The region where the α- and β-MyHC isoform specific peptides differ was examined to find a suitable residue to mutate. The rationale was to maintain the regions where the α- and β-MyHC isoform specific peptides are the same so that the internal standard peptide could be used for both isoform peptides. The internal standard peptide should have a mass that is not found in the samples so that its signal is not contaminated by endogenous peptides. The mass range between the isoform peptides was free of peptide signal therefore the internal standard was designed to appear in this region. The α-MyHC isoform peptide was chosen as the starting point. A conservative hydrophobic amino acid substitution, Isoleucine-7 to Valine (see FIG. 2), was selected as this substitution produces little change in chemical properties and yields a peptide product with a mass intermediate between the isoform peptides.

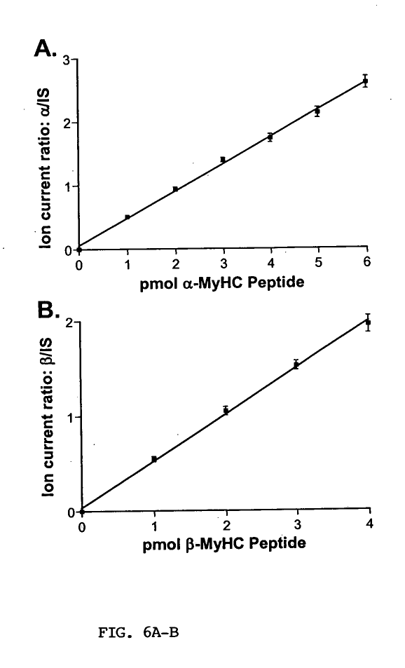

Preparation of peptide standard mixtures and generation of standard curves. The internal standard (IS) peptide was mixed with the synthetic α- and β-MyHC peptides to generate standard curves. Each spot contained 2 pmol of IS and either 0-6 pmol of the synthetic α-MyHC peptide or 0-4 pmol of the synthetic β-MyHC peptide. The ion current ratio of the α-MyHC peptide/IS peptide was graphed against the pmol of α-MyHC peptide (FIG. 6A). The relationship was linear (r2=0.994). Likewise, the ion current ratio of the α-MyHC peptide/IS peptide was graphed against the pmol of β-MyHC peptide and shown in FIG. 6B. This relationship was also linear (r2=0.998). Higher order analysis did not significantly improve the curve fit of either standard curve.

Linearity of the assay with protein amount. A protein sample containing partially purified myosin was electrophoresed on duplicate gels with loads of 0, 1, 2, 3, or 4 micrograms of total protein. The MyHC was excised and processed as described in the experimental procedures. The tryptic digests were supplemented with 2 pmol of the IS peptide and subjected to MALDI-TOF MS. The ion current ratios of the α-MyHC peptide/IS peptide and the β-MyHC peptide/IS peptide were measured, and then converted to pmol of each peptide using the standard curves. The pmol of α-MyHC and β-MyHC are graphed against the micrograms of total protein in FIG. 7. The amount of α-MyHC was linear with total protein amount (r2=0.999) and the amount of β-MyHC was also linear with respect to total protein amount (r2=0.998).

Quantification of α-MyHC and β-MyHC in a Panel of Atrial Samples. The panel of samples of partially purified myosin was electrophoresed on duplicate gels with a loading of 3 micrograms total protein. The MyHC band was excised and processed as described in the experimental section. The tryptic digests were supplemented with 2 pmol IS peptide and subjected to MALDI-TOF MS. A representative spectrum is shown in FIG. 3B. The ion current ratios of the α-MyHC peptide/IS peptide and the β-MyHC peptide/IS peptide were measured. The pmol of each peptide and hence the pmol of each isoform were determined from the standard curves and tabulated in Table 1. From these amounts, the pmol α-MyHC/microgram total protein and the pmol β-MyHC/microgram total protein were calculated and shown in Table 1. The absolute amounts of the isoforms determined by this assay were also used to calculate the percentage of α-MyHC. These values are in agreement with the relative amounts determined by the isoform ratio method described above. The combined amounts of α- and β-MyHC in each sample, 1.15-1.86 pmol/microgram, translate to 26%-41% of the total protein in these partially purified preparations being MyHC. This corresponds to the relative amount of MyHC seen in these preparations by Coomassie staining of the gels.

TABLE 1
Amounts of α- and β- MyHC isoforms in a panel of patient samples.

| | pmol | pmol α-MyHC/ | pmol | pmol β-MyHC/ | % pmol |
|---|---|---|---|---|---|
| Patient | α-MyHC | μg protein | β-MyHC | μg protein | α-MyHC |
| 1 | 4.83 +/− 0.21 | 1.609 +/− 0.071 | 0.84 +/− 0.05 | 0.281 +/− 0.016 | 85.14 +/− 0.69 |
| 2 | 1.74 +/− 0.11 | 0.579 +/− 0.036 | 2.00 +/− 0.08 | 0.667 +/− 0.027 | 46.46 +/− 1.34 |
| 3 | 3.26 +/− 0.20 | 1.085 +/− 0.066 | 0.55 +/− 0.07 | 0.185 +/− 0.024 | 85.51 +/− 1.19 |
| 4 | 2.63 +/− 0.11 | 0.878 +/− 0.038 | 0.86 +/− 0.05 | 0.285 +/− 0.015 | 75.47 +/− 1.34 |
| 5 | 3.48 +/− 0.15 | 1.159 +/− 0.052 | 0.48 +/− 0.05 | 0.160 +/− 0.016 | 87.86 +/− 0.95 |
| 6 | 2.39 +/− 0.08 | 0.796 +/− 0.025 | 2.27 +/− 0.06 | 0.757 +/− 0.019 | 51.26 +/− 0.85 |
| 7 | 3.35 +/− 0.19 | 1.118 +/− 0.064 | 0.57 +/− 0.04 | 0.190 +/− 0.015 | 85.49 +/− 0.92 |

Aliquots containing 3 mg of total protein from the panel of partially purified myosin samples were electrophoresed on SDS gels. The MyHC band was excised and analyzed for the amounts of the α- and β-MyHC isoforms. The amounts are expressed as pmol and as pmol/mg protein. The values are used to calculate the % pmol α-MyHC which is 100×pmol α-MyHC/(pmol α-MyHC+pmol β-MyHC). All values are averages+/−standard deviations for ten measurements. The % pmol α-MyHC values from the absolute amount measurements are consistent with the % α-MyHC determined by the isoform ratio method.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods, and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### IX. REFERENCES

The following references, to the extent that they provide exemplary procedural or other details supplementary to those set forth herein, are specifically incorporated herein by reference:

Alonso et al., J. Mol. Biol., 211:727, 1990.

Anderson et al., Eletrophoresis 18:533, 1997.

Axelsson et al., J. Am. Soc. Mass Spectrom., 10:104, 1999.

Bahret al., J. Mass. Spectrom., 32:1111, 1997.

Beavis and Xiang, Org. Mass Spectrom. 28:1424, 1993.

Bentzley et al., Anal. Chem., 68:2141, 1996.

Blackledge et al., Anal. Chem. 67:843, 1995

Boheler and Moorman, Eur. Heart J., 16SuppN:3, 1995.

Boheler et al., J. Clin. Invest., 88:323, 1991.

Bouvagnet et al., Basic Res. Cardiol., 84:91, 1989.

Brown et al., Proc. of the 45^{th} ASMS Conf. on Mass Spectrom. & Allied Tops., 1997.

Bucknall et al., Journal of American Society of Mass Spectrometry (In Press) 2002.

Caprioli et al., Anal. Chem., 69:4751, 1997.

Caforio et al., Circulation, 5:1734-1742, 1992.

Chaurand et al., Anal. Chem., 71:5263, 1999.

Chen et al., J Chromatogr. B. Biomed. Sci. Appl., 755, 2000.

Clark et al., J. Biol. Chem., 257:5449, 1982.

Clench et al., Rapid Commun. Mass Spectrom., 13:264, 1999.

Dechesne et al., Circ. Res., 57:767, 1985.

Desiderio et al., Biopolymers, 40:257, 1996.

dos Remedios et al., Eletrophoresis, 17:235, 1996.

Duncan et al., Rapid Commun. Mass Spectrom., 7:1090, 1993.

Faulstich et al., Anal. Chem., 69:4349, 1997.

Fitzsimons et al., Am. J. Physiol., 276:H1511, 1999.

Gobom et al., Anal. Chem. 72:3320, 2000.

Gorza et al., Circ. Res., 54:694, 1984.

Gregario and Antin, Trends Cell. Biol., 10:355, 2000.

Guo et al., Anal. Chem. 71, 1999.

Gygi et al., Mol. Cell. Biol., 19:1720, 1999.

Harris et al., J Muscle Cell Motil., 15:11, 1994.

Herron et al., Circ. Res., 90:1150, 2002.

Hewett et al., Circ. Res., 74:740, 1994.

Hillenkamp and Karas, Anal. Chem., 60:2299, 1988.

Hoh et al., J. Mol. Cell. Cardiol., 10:1053, 1978.

Horak et al., Rapid Commun. Mass Spectrom., 15:241, 2001.

Hutchens et al., Rapid Commun. Mass Spectrom. 7:5776, 1993.

Jespersen et al., Anal. Chem., 71:660, 1999.

Jiang et al., J. Agric. Food Chem., 48:3305, 2000.

Jones et al., J. Clin. Invest., 98:1906, 1996.

Kanazawa et al., Biol. Pharm. Bull., 22:339, 1999.

Kazmaier et al., Fres. J Anal. Chem., 361:473, 1998.

Kinsel et al., Anal. Chem., 71:268, 1999.

Kochling and Biemann, Proc. of the 43rd Annual ASMS Conf. on Mass Spectrom. and Allied Topics, 1995).

Kumar et al., Proc. Nat'l Acad. Sci., 94:4406, 1997.

Li et al., Trends Biotechnol., 18:151, 2000.

Li et al., Anal. Chem., 71:5451, 1999.

Li et al., Anal. Chem., 71:1087, 1999.

Li et al., J. Am. Chem. Soc., 118:11662, 1996.

Lim et al., J. Am. Coll. Cardiol., 38:1175, 2001.

Littlefield and Fowler, Annu. Rev. Cell. Dev. Biol., 14:487, 1998.

Lompre et al., Nature, 282:105, 1979.

Lovelace et al., J Chromatogr., 562:573, 1991.

Lowes et al., J. Clin. Invest., 100:2315, 1997.

Lowes et al., N. Engl. J. Med., 346:1357, 2002.

Lynn et al., Rapid Commun. Mass Spectrom., 13:2022, 1999.

Marie et al., Anal. Chem., 72:5106, 2000.

Martin et al., Circ. Res., 50:117, 1982.

Mercadier et al., Bull. Acad. Nat'l Med., 177:917, 1993.

Miketova et al., Mol. Biotechnol., 8:249, 1997.

Mirgorodskaya et al., Rapid Commun. Mass Spectrom., 14:1226, 2000.

Miyata et al., Circ. Res., 86:386, 2000.

Mogensen et al., J. Clin. Invest., 103:R39, 1999.

Muddiman et al., Fres. J Anal. Chem., 354:103, 1996.

Nadal-Ginard et al., J. Clin. Invest., 84:1693, 1989.

Nakao et al., J. Clin. Invest., 100:2362, 1997.

Nelson et al., Anal. Chem., 66:1408, 1994.

Nguyen et al., J. Chromatogr., 705:21, 1995.

Orenstein et al., J. Clin. Invest., 96:858, 1995.

Orlando et al., Anal. Chem., 69:4716, 1997.

Owens et al., Rapid Commun. Mass Spectrom., 11:209, 1997.

Pagani et al., Am. J. Physiol., 245:H713, 1983.

Parker et al., Can. J. Appl. Physiol., 23:377, 1998.

Perera et al., Rapid Commun. Mass Spectrom., 9:180, 1995.

Perreault et al., Anal. Chem., 70:5142, 1998.

Philip et al., Electrophoresis, 18:382, 1997.

Preston et al., Biol. Mass Spectrom., 22:544, 1993.

Rayment et al., Science, 261:58, 1993.

Reiser et al., Physiol. Heart Circ. Physiol., 280:H1814, 2001.

Razumova et al., Biophys. J, 80:261a, 2001.

Reiser et al., Physiol. Heart Circ. Physiol., 280:H1814, 2001.

Reiser et al., Am. J. Physiol., 274:H1048, 1998.

Roepstorff et al., Exs., 88:81, 2000.

Rouslin et al., Am. J. Physiol., 270:C1271, 1996.

Rubenstein, Bioessays, 12:309, 1990.

Russell et al., Int. J. Mass Spectrom. 182/183, 1999.

Sata et al., Circ. Res., 73:696, 1993.

Schleuder et al., Anal. Chem., 71:3238, 1999.

Schwartz et al., J. Am. Coll. Cardiol., 22:30A, 1993.

Schwartz et al., Basic Res. Cardiol., 87:285, 1992.

Schwartz et al., J. Mol. Cell Cardiol., 13:1071, 1981.

Stoeckli et al., Nat. Med., 7:493, 2001.

Stoeckli et al., J. Am. Soc. Mass Spectrom., 10:67, 1999.

Sutoh et al., Proc. Nat'l Acad. Sci., 88:7711, 1991.

Swynghedauw et al., Physiol. Rev., 66:710, 1986.

Takach et al., J Protein Chem., 16:363, 1997.

Tan et al., Anal. Biochem. 131:99, 1983.

Tsoporis et al., J. Biol. Chem., 272:31915, 1997.

Van Buren et al., Circ. Res., 77:439, 1995.

Vendekerckhove et al., J. Biol. Chem., 272:31915, 1986.

Villanueva et al., Enzyme Microb. Technol., 29:99, 2001.

Vorm et al., Anal. Chem., 66:3281, 1994.

Wang et al., J. Agric. Food. Chem., 48:2807, 2000.

Wang et al., J. Agric. Food. Chem., 48:3330, 2000.

Wang et al., J. Agric. Food. Chem., 47:1549, 1999.

Wang et al., J. Agric. Food. Chem., 47:2009, 1999.

Wilkins et al., J. Am. Soc. Mass Spectrom. 9:805, 1998.

Wittmann et al., Biotechnol. Bioeng., 72:642, 2001.

Woods et al., Anal. Chem. 70:750, 1998.

Wu et al., Anal. Chem., 72:61, 2000.

Wu et al., Anal. Chem., 70:456A, 1998.

Yang et al., J. Agric. Food. Chem., 48:3990, 2000.

Zaluzec et al., Protein Expr. Purif., 6:109, 1995.

Zhang et al., Chromatogr. B. Biomed. Sci. Appl., 757:151, 2001.

Zhang and Caprioli, J. Mass Spectrom., 31:690, 1996.

Zhong et al., Clin. Chem. ACTA., 313:147, 2001.

Zhu et al., Peptides, 16:1097, 1995.

Zweigenbaum et al., Anal. Chem., 71:2294, 1999.

Zweigenbaum et al., Anal. Chem., 74:2446, 2000.

What is claimed is:

1. A method of quantitating the amount of a protein or peptide in a sample comprising:
(a) obtaining a sample containing said protein or peptide;
(b) providing a standard protein or peptide wherein the standard is a derivative of the protein or peptide of interest at a known or measurable quantity;
(c) co-crystallizing the protein or peptide and standard with a matrix;
(d) analyzing the crystallized target protein or peptide and standard using matrix-assisted laser dissorption/ionization time of flight (MALDI-TOF) mass spectrometry; and
(e) determining the amount of the protein or peptide present in the sample based on the analysis in (d).

2. The method of claim 1, wherein said sample is derived from a cell.

3. The method of claim 2, wherein said cell is a prokaryotic cell.

4. The method of claim 2, wherein said cell is a eukaryotic cell.

5. The method of claim 2, wherein said cell is a mammalian cell.

6. The method of claim 2, wherein said cell is a human cell.

7. The method of claim 6, wherein said human cell is a cardiomyocte.

8. The method of claim 1, wherein said sample is derived from an organ.

9. The method of claim 8, wherein said organ is a heart.

10. The method of claim 8, wherein said sample is organ is a human heart.

11. The method of claim 1, wherein said sample is obtained from plasma.

12. The method of claim 1, wherein said sample is obtained from serum.

13. The method of claim 1, wherein said source has been exposed to an agent that alters the expression or structure of the protein or peptide.

14. The method of claim 1, wherein the protein is alpha myosin heavy chain.

15. The method of claim 1, wherein the protein is beta myosin heavy chain.

16. The method of claim 1, wherein the protein is cardiac actin.

17. The method of claim 1, wherein the protein is skeletal actin.

18. The method of claim 1, wherein the peptide is produced by proteolytic cleavage.

19. The method of claim 1, wherein the peptide is produced by chemical cleavage.

20. The method of claim 1, wherein the peptide is produced by enzymatic digestion.

21. The method of claim 20, wherein the enzymatic digestion is performed by an endopeptidase.

22. The method of claim 20, wherein the enzymatic digestion is performed by a protease.

23. The method of claim 1, wherein the protein, peptide and/or standard are produced synthetically.

24. The method of claim 1, wherein the standard is designed by modifying a single amino acid from the target protein or peptide.

25. A method of quantitatively comparing the amount of a plurality of structurally distinct proteins or peptides in a sample comprising:
(a) obtaining one or more samples containing said multiply distinct target proteins or peptides;
(b) providing a standard protein or peptide for each target protein, wherein the standard is a derivative of the target protein or peptide of interest at a known or measurable quantity;
(c) co-crystallizing the target proteins or peptides and standard with a matrix;
(d) analyzing the crystallized target proteins or peptides and standard using matrix-assisted laser dissorption/ionization time of flight (MALDI-TOF) mass spectrometry; and
(e) determining relative or absolute amounts of each target protein or peptide analyzed that is present in the sample.

26. The method of claim 25, wherein the proteins are isoforms of each other.

27. The method of claim 26, wherein the isomers are phosphoisomers.

28. The method of claim 25, wherein said sample is derived from a cell.

29. The method of claim 28, wherein said cell is a prokaryotic cell.

30. The method of claim 28, wherein said cell is a eukaryotic cell.

31. The method of claim 28, wherein said cell is a mammalian cell.

32. The method of claim 28, wherein said cell is a human cell.

33. The method of claim 32, wherein said human cell is a cardiomyocte.

34. The method of claim 25, wherein said sample is derived from an organ.

35. The method of claim 34, wherein said sample organ is a heart.

36. The method of claim 34, wherein said organ is a human heart.

37. The method of claim 25, wherein said sample is obtained from plasma.

38. The method of claim 25, wherein said sample is obtained from serum.

39. The method of claim 25, wherein said source has been exposed to an agent that alters the expression or structure of the proteins or peptides.

40. The method of claim 25, wherein one of the proteins is α-myosin heavy chain.

41. The method of claim 25, wherein one of the proteins is P-myosin heavy chain.

42. The method of claim 25, wherein one of the proteins is cardiac actin.

43. The method of claim 25, wherein one of the proteins is skeletal actin.

44. The method of claim 25, wherein the peptides are produced by proteolytic cleavage.

45. The method of claim 25, wherein the peptides are produced by chemical cleavage.

46. The method of claim 25, wherein the peptides are produced by enzymatic digestion.

47. The method of claim 46, wherein the enzymatic digestion is performed by an endopeptidase.

48. The method of claim 46, wherein the enzymatic digestion is performed by a protease.

49. The method of claim, 25, wherein the proteins, peptides and/or standards are produced synthetically.

50. The method of claim 25, wherein the standards are proteins or peptides derived or synthesized directly from the proteins of interest.

51. The method of claim 25, wherein the standard are designed by modifying a single amino acid from the target proteins or peptides.

52. A method of determining relative amounts of at least two distinct proteins or peptides in a sample comprising:
(a) obtaining a samples containing said multiply distinct target proteins or peptides;
(b) co-crystallizing the target proteins or peptides and standard with a matrix;
(c) analyzing the crystallized target proteins or peptides using matrix-assisted laser dissorption/ionization time of flight (MALDI-TOF) mass spectrometry; and
(d) determining the relative amount of each target protein or peptide analyzed that is present in the sample.
